(19) United States
(12) Patent Application Publication
(10) Pub. No.: US 2026/0061724 A1
(43) Pub. Date: Mar. 5, 2026

(54) METHOD FOR PREPARING A MULTILAYER SELF-HEALING ELECTRICALLY CONDUCTING ELASTOMER FILM, A MULTILAYER SELF-HEALING ELECTRICALLY CONDUCTING ELASTOMER FILM, A METHOD FOR PREPARING AN ELECTRONIC DEVICE, AND AN ELECTRONIC DEVICE COMPRISING THE MULTILAYER SELF-HEALING ELECTRICALLY CONDUCTING ELASTOMER FILM

(71) Applicant: University of Oulu, University of Oulu (FI)

(72) Inventors: Jarkko TOLVANEN, Oulun yliopisto (FI); Ahmed Albeltagi, Oulun yliopisto (FI); Mikko Nelo, Oulun yliopisto (FI); Jari Hannu, Oulun yliopisto (FI); Jari Juuti, Oulun yliopisto (FI); Heli Jantunen, Oulun yliopisto (FI)

(21) Appl. No.: 19/311,911

(22) Filed: Aug. 27, 2025

(30) Foreign Application Priority Data
Aug. 30, 2024 (EP) 24197471.6
Aug. 30, 2024 (EP) 24197480.7
Oct. 31, 2024 (EP) 24210058.4

(51) Int. Cl. B32B 15/08; B23K 26/352; B23K 101/40; B32B 27/26

(52) U.S. Cl. CPC B32B 15/08; B23K 26/355; B32B 27/26; B23K 2101/40; B32B 2255/10; B32B 2255/205; B32B 2307/202; B32B 2307/206; B32B 2307/762

(57) ABSTRACT

A method for preparing a multilayer self-healing electrically conducting elastomer film, the method comprising: providing an electrically insulating substrate layer comprising an elastomer matrix; applying a first layer comprising a self-healing elastomer on top of the electrically insulating substrate layer; crosslinking the first layer comprising a self-healing elastomer with the electrically insulating substrate layer; applying a layer comprising a self-healing electrically conducting liquid metal elastomer composite comprising gallium as main phase on top of the first layer comprising a self-healing elastomer; and activating the surface of the layer comprising a self-healing electrically conducting liquid metal elastomer composite with laser to improve electric conductivity of the layer. A multilayer self-healing electrically conducting elastomer film, a method for preparing an electronic device, and an electronic device comprising the multilayer self-healing electrically conducting elastomer film.

### CROSS-REFERENCE TO RELATED APPLICATIONS

This application claims priority to European Patent Application No. 24197471.6, filed on Aug. 30, 2024, European Patent Application No. 24197480.7, filed on Aug. 30, 2024, and European Patent Application No. 24210058.4, dated Oct. 31, 2025, the disclosures of each of which are hereby incorporated by reference in their entireties.

### FIELD OF THE APPLICATION

The present application relates to a method for preparing a multilayer self-healing electrically conducting elastomer film, and to a multilayer self-healing electrically conducting elastomer film. The present application also relates electronic devices comprising the multilayer self-healing electrically conducting elastomer film and to a method for preparing thereof.

### BACKGROUND

There exist relatively few electrically conductive multilayer structures comprising self-healing elastomers, although they could not only contribute to solving the printed electronics manufacturing challenges, but also improve the performance of stretchable devices, components, and circuits. So far, the prior art self-healing materials exhibit limitations in the achievable levels of electrical conductivity, stretchability before partial or complete electrical or mechanical failure, cyclic fatigue resistance, durability for different mechanical loading and environmental conditions. For example, typically, stretchable interconnections on soft substrates are highly sensitive stretching, and any macroscopic damage formed may easily propagate resulting in a catastrophic failure of device; which can be partly mitigated or even prevented with the use of self-healing intermediate layers, or multilayered conductive films. More importantly, there is a need to find better self-healing materials for soft force and touch sensors enabling controllability over important parameters, such as sensitivity, linearity, detection limit, hysteresis, response times, and measurement range.

### SUMMARY

In the present invention, methods, materials and products were obtained which can overcome drawbacks of the prior art. With the present products, materials and methods, it was possible to not only obtain better self-healing elastomeric materials as multilayer structures, such as films, but also to resolve some of the manufacturing challenges encountered with soft electronics made on polymer substrates. As the present structures represent a novel field of materials comprising liquid metal elastomer composite, they can provide solutions to problems not even recognized or existing previously.

The obtained materials and products can be used in a variety of different electronics solutions, such as in electronic devices, components, structures and/or parts thereof. More particularly, the present methods and materials use autonomously self-healing elastomers which can be used for example in a variety of soft and printed electronics as substrates and as a base material for a wide variety of soft and/or flexible and/or stretchable electronic components, e.g. actuators, energy harvesters, sensors, capacitors, conductors, resistors, insulators, encryption devices, etc. Autonomous self-healing materials can also be used in a variety of mechanical applications for example as sealants, moisture insulation, rubber spring/dampers, coatings, etc. It is possible to obtain completely autonomously self-healing multilayer materials and devices based on the materials.

The present multilayer structures enable printing and/or utilization of liquid metal elastomers as electrically conductive surfaces, layers, or structures on substrates, onto which direct printing thereof has not been possible due the substrate material properties and incompatibility. The use of liquid metal elastomers also provides a variety of advantageous properties and enables providing multilayer materials which have novel and/or improved electrical and/or electro-mechanical properties.

The present application provides a method for preparing a multilayer self-healing electrically conducting elastomer film, the method comprising: —providing an electrically insulating substrate layer comprising an elastomer matrix, —applying, such as printing, a first layer comprising a self-healing elastomer on top of the electrically insulating substrate layer, —crosslinking the first layer comprising a self-healing elastomer with the electrically insulating substrate layer, —applying, such as printing, a layer comprising a self-healing electrically conducting liquid metal elastomer composite comprising gallium as main phase on top of the first layer comprising a self-healing elastomer, and—activating the surface of the layer comprising a self-healing electrically conducting liquid metal elastomer composite with laser to improve electric conductivity of the layer.

The present application also provides a multilayer self-healing electrically conducting elastomer film, comprising—an electrically insulating substrate layer comprising an elastomer matrix, —a first layer comprising a self-healing elastomer crosslinked with the electrically insulating substrate layer, and—a layer comprising a self-healing electrically conducting liquid metal elastomer composite comprising gallium as main phase on top of the first layer comprising a self-healing elastomer.

One embodiment provides a multilayer self-healing electrically conducting elastomer film, comprising—an electrically insulating substrate layer comprising an elastomer matrix, —a first layer comprising a self-healing elastomer crosslinked with the electrically insulating substrate layer, —a second layer comprising a self-healing electrically conducting elastomer on top of the first layer, and—a layer comprising a self-healing electrically conducting liquid metal elastomer composite comprising gallium as main phase on top of the second layer comprising a self-healing electrically conducting elastomer.

The present application also provides a method for preparing an electronic device, or part thereof, the method comprising—providing one or more multilayer self-healing electrically conducting elastomer films, —providing one or more electrical components, and—combining the one or more multilayer self-healing electrically conducting elastomer films with the one or more electrical components to obtain an electronic device, or a part thereof, comprising the multilayer self-healing electrically conducting elastomer film(s).

The present application also provides an electronic device, or a part thereof, comprising the multilayer self-healing electrically conducting elastomer film.

The main embodiments are characterized in the independent claims. Various embodiments are disclosed in the dependent claims. The embodiments and examples disclosed herein are mutually freely combinable unless otherwise explicitly stated. The embodiment and examples not in the scope of the claims may be considered as embodiments and examples useful for understanding the invention.

With the present multilayer structures, it is possible to obtain, for example, a substantial increase in electric conductivity after a laser activation of a liquid metal layer and extended stretching range compared to the same materials, or single layered conductive films on a substrate. For example, the conductivity improved by a factor of 1.5-5.0 when electrically conductive liquid metal elastomer (ECLME) contained no cellulose (such as, up to 5000 S cm⁻¹ without strain), and about 1.4-fold improvement for cellulosed-based ECLME composition (such as, up to 10 000 S cm⁻¹ without strain), for example, when made on commercially available platinum cure-based silicone rubbers.

Also, as shown, the stretching range of the ECLME-based conductive films made on silicone rubber can be improved by over two-fold with the use of at least one self-healing elastomer of any type as intermediate layer. Similarly, the combination of distinct conductive materials and intermediate layer(s) in a multilayer structure can modify the final properties including but not limited to elongation range before electrical failure, change of resistance in relation to applied strain (i.e., strain sensitivity), cyclic fatigue resistance, thermal stability, ultimate durability of the structure (i.e., how much force can be applied without delamination, etc.), electro-mechanical hysteresis, adhesion between layers and to other functional parts of the device (such as, surface-mount components and ICs), temperature stability and heat dissipation capability.

With the present intermediate layer, the liquid metal elastomer composite could be printed in practice on any substrate, and a good electrical conductivity could be achieved after a laser activation.

It is possible, for example, to tune the properties of the materials and the material structures, and utilize them as or in electrical conductors, electrical connectors, resistors, and piezoresistive sensors without further modifications in their composition as the functionality can be adjusted by structural design and combination of different materials.

The different self-healing elastomers, blends thereof, composites based on the same base polymer backbone, and multilayer films and/or structures comprising thereof, can be accurately patterned after cross-linking. The patterned self-healing films can be transfer printed from a donor substrate, with weaker adhesion, to other materials or surfaces, with stronger adhesion, or to self-healing substrate or material structures via reversible cross-links capable of establishing chemical bonds between the layers. The first method is widely applicable for wide range of materials, considering adhesion at the interfaces is controlled by the choice of donor and acceptor material, whereas the latter only requires that the used self-healing materials are compatible with each other, for example, based on the same polymer matrix.

Patternability of the self-healing material by laser enables forming patterned films at high precision, after cross-linking and/or curing, without permanently damaging the materials that can be otherwise vulnerable to formation of microstructural damages, thus propagation of fractures/defects under mechanical deformation, especially if the possible self-healing is neglected. Methods for patterning of soft functional materials are especially essential for fabricating small and reliable soft electronics devices and circuits.

### BRIEF DESCRIPTION OF THE FIGURES

FIG. 1 shows a flowchart of the method.

FIG. 2 shows a flowchart of a mixing sequence for preparing electrically conductive liquid metal elastomers.

FIG. 3 shows a flowchart of another mixing sequence for preparing electrically conductive liquid metal elastomers.

FIG. 4 shows a flowchart of another mixing sequence for preparing electrically conductive liquid metal elastomers. Optional ingredients are presented with dashed lines.

FIG. 5 shows a SEM image of liquid metal microparticles (LMMPs) obtained by ultrasound treatment.

FIG. 6 shows a SEM image of a surface of a film made by using a mixture of liquid metal particles and carbon nanotubes, where the amount of liquid metal was 60 vol. %.

FIG. 7 shows general examples of the multilayer films.

FIG. 8 shows specific examples of the multilayer films.

FIGS. 9A-9E show relative resistance change (ΔR/R₀) plotted as a function of uniaxial tensile strain for a) 2PEC7 PEDOT-based elastomer compositions on Dragon Skin™ elastomer, b) EC7-LM65-CNT2.25 electrically conductive liquid metal elastomers (ECLME) compositions on Dragon Skin™ elastomer, c) multilayered conductor consisting of substrate, 2PEC7 intermediate layer, and a second conductive layer made of EC7-LM65-CNT2.25 ECLME, d) EC7-LM65-CNT0.75 ECLME on Dragon Skin™ elastomer, and e) multilayer conductor consisting of substrate, EC7 self-healing, electrically insulating elastomer as intermediate layer, and the first conductive layer made of EC7-LM65-CNT0.75 ECLME. In this case, for example, vertical printing and/or lasering (denoted with “V”) is along the uniaxial stretching direction. The first letter indicates the printing direction, and the second letter the lasering direction (in the case of ECLME).

FIG. 10 shows photographs of different liquid metal elastomer composition made by using carbon nanotubes, carbon nanotubes and hydroxypropyl cellulose mixed with water, and carbon nanotubes and hydroxypropyl cellulose mixed with toluene. The printed conductors on Dragon Skin™ elastomer are under uniaxial stretching.

FIGS. 11A and 11B show R/R₀ measured as a function of uniaxial stretching. The printed conductors are denoted as follows: in a) w/S=with a surfactant, w/o S=without a surfactant, enc-(w/o S)=encapsulated and without a surfactant, and in B) P=pristine and the times 24/48/72 h refer to the self-healing time from the point of time where the sample was completely cut through on specific location. The photos show pristine sample under stretching (the left, scale bar 25 mm) and self-healed sample which has been cut and then healed (right, scale bar=0.3 mm). The liquid metal elastomers were printed onto a self-healing elastomer substrate.

FIG. 12 shows particle size analysis. The particle size distribution was measured with Zetasizer Nano ZS from a diluted liquid metal mixture.

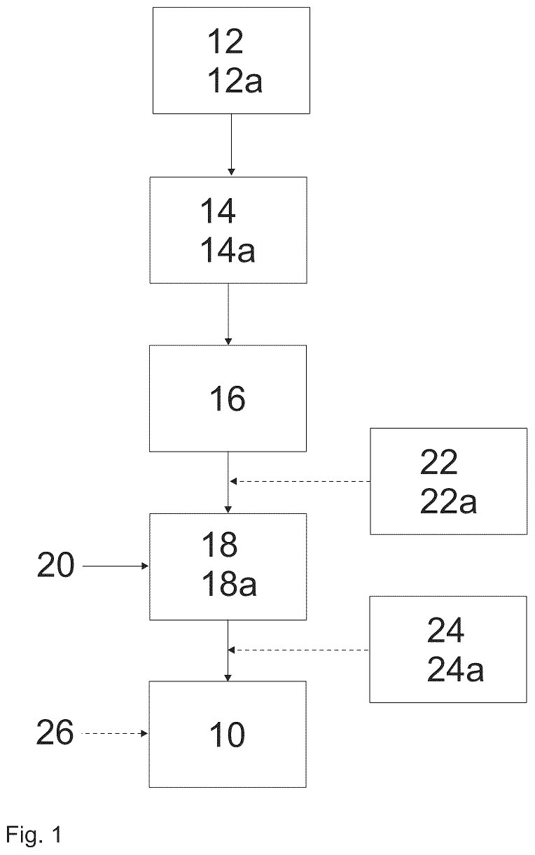

### DETAILED DESCRIPTION

In this specification, percentage values, unless specifically indicated otherwise, are based on weight (w/w, by weight, or wt %). In specific examples the embodiments and examples, or features thereof, specified with the open term “comprise” may be further limited with a closed term “consisting of”.

The diameters disclosed herein, unless specifically indicated otherwise, may refer to the smallest diameter, and may be presented as average or number-average diameter. The diameter may be also presented as equivalent spherical diameter. The diameter may be determined microscopically or by other optical methods, which may comprise using a camera, and/or by sieve analysis. More particularly, the disclosed dimensions or other features may be measured by image analysis of microscope images, such as images from a light microscope, a field emission scanning electron microscope (FE-SEM), a transmission electron microscope (TEM), such as a cryogenic transmission electron microscope (CRYO-TEM), or an atomic force microscope (AFM). Suitable imaging and/or analysis software may be used to determine the dimensions and/or the other features.

In the manufacturing of the printed and flexible electronics, rheological properties of functional inks and pastes needs to be carefully selected for each specific printing method to achieve a high coating or film uniformity and patterning precision. Surface treatments are required to increase the low surface energy and improve the poor wettability encountered with polymer substrates due to their molecular structure and intermolecular forces resulting also in less polar and reactive surfaces. Mismatches in the coefficient of thermal expansions (CTEs) and Young's moduli of materials, high surface roughness and insufficient adhesion at the material interfaces raises significant challenges for achieving durable and highly deformable multilayered interconnections, and component or device architectures.

Despite significant advancements in the manufacturing of soft electronics, several challenges for designing reliably operating functional devices for the extreme deformations exist resulting in compromise of long-term durability and stability of the devices. For soft electronics, developing intermediate layers was found particularly important to enhance electrical and electro-mechanical properties, and the durability of soft multilayered structures by improving the functional material deposition, material compatibility, chemical and/or mechanical bonding of passive and active layers to soft substrate. An improvement of both electrical properties and adhesion with the layers is achievable by the reducement in the number of defects, pinholes, inhomogeneities and thickness variations of the layers through modification of the surface energy and smoothness, and by a more controlled deposition, for example, by a better control over the evaporation rate of a solvent during drying and curing steps with the use of intermediate layer(s). Adhesion degradation over time by temperature variations, humidity and moisture, UV exposure, and mechanical stress can result in complete mechanical and electrical failure of the device without additional considerations. By achieving soft and stretchable intermediate layer with universal compatibility and adhesion, a good and reliable bonding to wide range of materials with vastly different physical, chemical and thermal properties could be achieved for also various environmental conditions; a critical factor determining the long-term functionality of soft electronics device. By introducing a self-healing intermediate layer, not only overall fatigue resistance could be improved through efficient absorption and dissipation of strain, but it is also possible to suppress the internal stresses due to CTE mismatch which may further prevent crack formation and propagation in the active layers of the device.

The resistance of a multilayer conductor can be determined with the following way.

The resistance of a single layer without stretching is

$$R = L / ( σ Wt ) ,$$

wherein L, σ, W, and t are the length, electrical conductivity, width and thickness, respectively.

Then, the total resistance of a multilayer conductor without stretching (parallel resistance, wherein i≥2) is:

$${R}_{total} = {( {\sum }_{i = 1}^{∞} \frac{1}{{R}_{i}} )}^{- 1} = {( \frac{1}{{R}_{1}} + \frac{1}{{R}_{2}} + \frac{1}{{R}_{3}} … )}^{- 1}$$

Thus, in practice the material with the lowest conductivity has substantially no effect to the total resistance of the conductor in the absence of stretching.

With uniaxial stretching the dimensions of the soft conductor change as follows:

$$length is {L}_{1}^{′} = {L}_{1} ( 1 + ε )$$

$$width is {W}_{1}^{′} = {W}_{1} ( 1 - {v}_{1} ε )$$

$$thickness is {t}_{1}^{′} = {t}_{1} ( 1 - {v}_{1} ε ) ,$$

wherein ε is the stretch and v is Poisson's ratio.

Thus, when taking into the consideration the deformation induced by the uniaxial tensile strain, the resistance of the soft conductor is:

$${R}^{′} = \frac{{L}_{1} ( 1 + ε )}{{σ}_{1} {W}_{1} ( 1 - {v}_{1} ε ) {t}_{1} ( 1 - {v}_{1} ε )}$$

And now a resistance of a multilayer conductor structure would be:

$$\begin{matrix}{R}_{total} = {( {\sum }_{i = 1}^{∞} \frac{1}{{R}_{i}^{′}} )}^{- 1} \\ = {( \frac{1}{R {′}_{1}} + \frac{1}{R {′}_{2}} + \frac{1}{R {′}_{3}} … )}^{- 1} \\ = {( \begin{matrix}\frac{1}{\frac{{L}_{1} ( 1 + ε )}{{σ}_{1} {W}_{1} ( 1 - {v}_{1} ε ) {t}_{1} ( 1 - {v}_{1} ε )}} + \frac{1}{\frac{{L}_{2} ( 1 + ε )}{{σ}_{2} {W}_{2} ( 1 - {v}_{2} ε ) {t}_{1} ( 1 - {v}_{2} ε )}} + \\ \frac{1}{\frac{{L}_{3} ( 1 + ε )}{{σ}_{3} {W}_{3} ( 1 - {v}_{3} ε ) {t}_{1} ( 1 - {v}_{3} ε )}} …\end{matrix} )}^{- 1}\end{matrix}$$

Thus, during stretching, Rₜₒₜₐₗ is still determined by the layer with the best conductivity, or the lowest resistance, (only if there is a very large difference in resistances), up to a certain point. The only difference is that in this case it is not necessarily the same layer as without stretching, if, for example, the layer with the best conductivity does not withstand as much stretching before cracking or completely breaking. In addition, the final working range of a stretchable conductor can be wider with multilayer structure than with those individual, single layered conductors, which can be due to many different things:

For example, if microcracks form in the conductive layer during stretching, the resistance increases dramatically with the distance of the gaps in the microcracks increasing (especially if there was no physical contact between the “islands” formed by the microcracks after a certain strain). In a multilayer structure, if a certain conductive layer would form microcracks (which does not necessarily happen due to more efficient transfer and distribution of stress), the “islands” could still be connected to each other through other conductive layers (above and/or below) by parallel connection. Thus, Rₜₒₜₐₗ of the conductor structure under strain would be significantly lower than without the layer forming the microcracks if the layer was highly conductive compared to the other conductive layers, and if those conductive islands did not change their shape during stretching.

The calculation of Rₜₒₜₐₗ could be also simplified in certain cases if it can be assumed that the stress is homogeneous in all layers and the mechanically stiffest layer determines the deformation of the entire conductor structure by the Poisson's ratio (i.e. how much the length changes in relation to the cross-sectional area). but the resistance of a multi-layer conductor during stretching becomes more complicated in reality, if and when the other layers affect how the previous layers function and behave. In addition, the deformation is rarely homogeneous in materials and the distribution of the deformation can be different at different points of the stretch, which affects the resistance of the multilayer conductor

In practice, by adjusting the geometry or shape, and dimensions of the different layers, as well as by changing the composition of the materials (which affects for example the electrical conductivity), multilayer conductors with novel properties and distinct electrical, mechanical, and electro-mechanical behavior can be achieved.

Materials ranging from insulators to semiconductors, and metallic conductors, having different levels of conductivity (10⁻¹⁸-10⁶ S cm⁻¹), strain sensitivity, flexibility or stretching range, Young's modulus, Poisson's ratio, hysteresis, and creep can be combined for developing various multilayered conductive structures with novel properties. Depending on the final application of the multilayered structure and used materials, also other properties of materials, such as thermal stability and CTE may be of consideration. Also, it is possible to combine a non-conductive material and a conductive material, but in this case, it does not directly affect the resistance of the conductor according to the formulas above. For example, a more conductive material (σ₁>>σ₂) with lower stretchability (ε_{1,max}<ε_{2,max}) can be combined with another conductivity material with lower conductivity (σ₂<<σ₁), but better stretchability (ε_{2,max}>ε_{2,max}. For example, this can result in a hybrid conductive material structure with extended stretchability, better conductivity at larger deformations, and more linear increase of a resistance as a function of the strain. However, predicting the final properties of multilayer conductor structure based on properties of individual materials is difficult.

The use of intermediate layer(s), and/or other conductive materials, to form hybrid multilayered conductive structures comprising liquid metal elastomer composite enables conductors that are not only a more durable, but have increased stretchability, and a lower resistance in the entire operating range. It is possible to control the change of resistance during stretching and create hybrid materials with completely new properties and stretching behavior, as was done in the present case.

The present application discloses a method for preparing a multilayer self-healing electrically conducting elastomer film 10, which may be called a film structure.

The method comprises providing 12a an electrically insulating substrate layer 12 comprising an elastomer matrix. The substrate may be any suitable substrate, such as disclosed herein. Examples of substrates include films, and fabrics, which may be polymeric, or any other suitable substrate. However, the substrate is preferably soft and flexible, in which case the present self-healing elastomer composites can exhibit their advantageous properties. The substrate may comprise or be any suitable elastomeric substrate, which may comprise or be based on for example silicone rubber; urethane rubber; thermoplastic elastomers, such as polyurethanes or styrene block copolymers; and/or self-healing poly(dimethyl)siloxane-based elastomers. One example of a substrate comprises a polyethylene terephthalate (PET) film, such as a non-silicone coated PET film. Further examples of substrates comprise elastomers, for example rubbers such as silicone rubbers or urethane rubbers, such as ones commercially available, for example Reynolds Dragon Skin™ (DS) or Vytaflex™. The substrate may be a self-healing elastomer. One example of a suitable commercially available non-conductive self-healing elastomeric substrate material is EC7.

The thickness of the substrate may be in the range of 10-1000 μm, such as 10-800 μm, 10-500 μm, 100-1000 μm, 100-800 μm, 100-500 μm, or 200-1000 μm.

The method comprises applying 14A a first layer 14 comprising a self-healing elastomer on top of the electrically insulating substrate layer. The applying 14a may comprise any suitable applying method, such as printing, tape casting and/or the like. The first layer 14 is an intermediate layer between the substrate 12 and the electrically conductive liquid metal elastomer composite layer 18.

In one example the method comprises
providing the self-healing elastomer as a paste or as a printing ink,
providing a substrate, and
applying, such as printing, the paste or the printing ink onto the substrate.

In one example the method comprises
providing the self-healing elastomer as a paste or as a flowable liquid,
providing a substrate, and
applying, such as casting or coating, the paste or the flowable liquid onto the substrate, preferably to obtain a coating on the substrate.

The first layer 14 may comprise any suitable self-heling elastomer. In one embodiment the self-healing elastomer comprises or is an electrically conducting elastomer 15. The electrically conducting elastomer may comprise a suitable self-healing elastomer, such as an elastomer comprising PEDOT:PSS, for example with 2PEC7 composition, and optionally fillers such as nanostructured and/or nanoscale fillers, for example metal nanoparticles; metal nanowires, such as silver, copper, or gold nanowires; carbon black; pyrolyzed lignin; graphite; carbon nanotubes; polymeric nanorods; nanofibrils; graphene, nanolayers selected from graphite, metallic layers and compounds comprising atomically thin layers of transition metal carbides, nitrides, or carbonitrides, such as MXenes; and/or other additives. One example of a suitable electrically conductive, self-healing PEDOT-based elastomer is 2PEC7 composition. 2PEC7 is used in examples disclosed herein, but the same teachings can be applied to other electrically conductive, self-healing elastomers as well.

In embodiments in the method or in the multilayer self-healing electrically conducting elastomer the first layer comprising a self-healing elastomer, the second layer comprising a self-healing electrically conducting elastomer and/or the third layer comprise a self-healing elastomer comprising PEDOT:PSS and optionally one or more fillers, preferably one or more nanostructured and/or nanoscale fillers, such as metal nanoparticles, carbon black, carbon nanotubes, metallic nano conductors, such as silver, copper and/or gold; nanorods, polymeric nanofibrils, graphene and/or nanolayers selected from graphite, metallic layers and compounds comprising atomically thin layers of transition metal carbides, nitrides, or carbonitrides, such as MXenes. In one example the multilayer structure of the self-healing, electrically conducting elastomer comprises or consists of the first layer comprising a self-healing elastomer, and two distinct self-healing, electrically conductive elastomer layers, such as a second layer comprising a self-healing electrically conducting elastomer and a third layer comprising a self-healing elastomer comprising PEDOT:PSS or other fillers. These, or other multilayer structures disclosed herein, may be further encapsulated and/or coated.

The multilayer self-healing electrically conducting elastomer discussed herein refers to the multilayer structure without encapsulating or the like coating, unless otherwise mentioned. In the simplest form, the multilayer structure comprises or consists of a non-conductive intermediate layer and a conductive elastomeric layer, preferably on a substrate, or two electrically conductive layers without an intermediate layer, preferably on a substrate. If there are more than one conductive layer, at least two different conductive elastomers and/or materials are needed

It may be preferred to combine a nanostructured and/or nanoscale filler-based elastomer with another electrically conductive coating or elastomer that forms cracks easily under stimulus (e.g., when stretched), especially if it is desired to make new types of piezoresistive sensor materials.

The nanostructured and/or nanoscale fillers, such as metallic nanowires, carbon nanotubes or polymer nanofibrils, which may be considered as so called one-dimensional nanomaterials and/or nanostructures, which are commonly defined as linear structures with diameter less than 100 nm, usually provide the best stretchability for the conductive network due to high aspect ratio and because the one-dimensional nanostructures/nanomaterials can slide in relative to each other while capable of also reorienting themselves inside the elastomer matrix without significant loss of the electrical conductivity up to a certain point. Other fillers do not achieve the same stretchability.

In a preferred option, the one-dimensional nanomaterials used as fillers are oriented, so that the filler distribution or an electrically percolated network formation is not completely random. In such case it is possible to combine, for example, elastomers with differently oriented nanowire networks, and it is possible to get different electro-mechanical behaviors upon application of strain.

The nanowires or alike, which may refer to any appliable one-dimensional nanomaterial in a form of wires, fibers or fibrils, may be oriented, for example, with solutions that are able to self-organize over time into a certain shape and/or structure that also drives the distribution and orientation of the fillers at the same time, or by using an external electric or magnetic field, or with ordinary etched silicon wafers or porous templates that define the orientation of the electrical network at the stage when the solution containing the nanoscale fillers is applied to the surface of a template.

In those cases, the elastomer material may also be made so that the conducting nanowire network is made separately, such as on the surface of a carrier substrate or template, and then the elastomer layer is cast or coated on top of the formed electrically percolated network, in which case the one-dimensional nanomaterials go partially inside the surface of the elastomer. This elastomeric layer can then be detached from the carrier substrate and added to a surface of another conductor. Such layer can be patterned either at this stage, or afterwards with a laser.

The method comprises crosslinking 16 the first layer comprising a self-healing elastomer with the electrically insulating substrate layer 12. The cross-linking may be obtained at elevated temperature. The cross-linking ensures a good adhesion of the first layer to the substrate. When the first layer is applied between the substrate and the liquid metal elastomer layer, a better electrical conductivity and adhesion between the layers can be obtained.

The method comprises applying 18a a layer 18 comprising a self-healing electrically conducting liquid metal elastomer composite comprising gallium as main phase on top of a substrate, which may be the first layer 14 comprising a self-healing elastomer. The applying 18a may comprise any suitable applying or depositing method, such as printing, tape casting and/or the like methods, such as disclosed herein.

In one example the method comprises
providing the self-healing electrically conducting liquid metal elastomer composite as a paste or as a printing ink,
providing a substrate, and
applying, such as printing, the paste or the printing ink onto the substrate.

In one example the method comprises
providing the self-healing electrically conducting liquid metal elastomer composite as a paste or as a flowable liquid,
providing a substrate, and
applying, such as casting or coating, the paste or the flowable liquid onto the substrate, preferably to obtain a coating on the substrate.

The method comprises activating 20 the surface of the layer 18 comprising a self-healing electrically conducting liquid metal elastomer composite with laser to improve electric conductivity of the layer. This shall be carried out before encapsulating or otherwise covering the structure or the electrically conducting liquid metal elastomer composite layer, which may be combined with other layers, structure and/or components before encapsulating/covering. The layer comprising a self-healing electrically conducting liquid metal elastomer composite may have been laser-sintered and/or electrical conductivity-improved, preferably by laser.

If the multilayer structures are used, for example, as circuit conductors, then the size and shape of the different layers in a multilayer structure shall be considered, for example, if surface mountable components and integrated circuits must be attached to one of the conductor layers, and the electric current has to flow correctly. Therefore, the combination of the insulating and the conductive layer is easier to use in all different applications as there is only one conductive layer (i.e. the insulating layer can be of any shape). If there are more than one conductive layer, then the shape of the individual conductive layers shall be considered more carefully, if they are not similar for some reason

Thus, in the majority of cases and applications disclosed herein the different conducting layers should have the same shape, but the dimensions do not necessarily have to be completely identical. The cross-sectional area of the layers may vary slightly, for example, in terms of thickness of the conductive material. If, for example, conductors and contact pads are made with a hybrid multilayered conductor structure, both different conductors should be in almost identical in size and placed similarly.

A layer that is more prone to stretching can be slightly smaller than another layer if the idea of the other layer is to distribute that tension more evenly. If the shape and size (width and/or length) of the conductive layers are not the same, then it also limits the density of its electronics integration, i.e. how many functions can be packed in the same area, because the conductive areas are only allowed to connect at certain points.

The method may further comprise applying a second layer comprising a self-healing electrically conducting elastomer on top of the first layer, before applying the layer comprising a self-healing electrically conducting liquid metal elastomer composite on top of the first layer and the second layer. The second layer is therefore an intermediate layer between the first layer and the self-healing electrically conducting liquid metal elastomer composite layer, and it acts as a substrate for applying the self-healing electrically conducting liquid metal elastomer composite layer. The first layer may be electrically non-conductive/insulating layer. Thus, adding a conductive intermediate layer produces a hybrid conductor with different type of conductive layer, which may have different material properties. Such hybrid conductors may be needed, e.g. if it is desired to better control how the resistance changes during stretching, or if a conductor structure is needed that can withstand very large stretches without geometric design. That is, they would mainly be good as sensor materials and in sensor structures to modify, for example, the sensor's sensitivity, response time, linearity, operating range, hysteresis, resolution, drift, creep, and sensitivity to other stimuli (e.g. temperature, humidity).

One embodiment provides a method for preparing a multilayer self-healing electrically conducting elastomer film, the method comprising
providing an electrically insulating substrate layer comprising an elastomer matrix,
applying a first layer comprising a self-healing elastomer on top of the electrically insulating substrate layer,
crosslinking the first layer comprising a self-healing elastomer with the electrically insulating substrate layer,
applying a second layer comprising a self-healing electrically conducting elastomer on top of the first layer,
applying a layer comprising a self-healing electrically conducting liquid metal elastomer composite comprising gallium as main phase on top of the second layer comprising a self-healing electrically conducting elastomer, and
activating the surface of the layer comprising a self-healing electrically conducting liquid metal elastomer composite with laser to improve electric conductivity of the layer.

An insulating intermediate layer and a conductor layer are not considered to produce a hybrid conductor due to lack of two or more different conductive materials, but the characteristics of the conductor layer can be improved even if the electro-mechanical behavior is similar.

For example, in the case of ECLME, only the electrical conductivity and the stretching area increased, but the response was similar in form. If the intermediate layer improves the manufacturing and microstructure of its conductive layer, then the properties can also differ from the original, but not nearly as much as with hybrid conductor structures, because they have two conductive layers and the contact resistance between the layers, in which case that resistance is then a combination of them and the tension is distributed differently in the layers.

In one embodiment the multilayer self-healing electrically conducting elastomer further comprises a second layer comprising a self-healing electrically conducting elastomer on top of the first layer, wherein the layer comprising a self-healing electrically conducting liquid metal elastomer composite is on top of the second layer.

The properties of the final multilayer conductor depend on the types of materials that are combined, the properties the individual materials have, and the shape, size and the orientation of the individual layers in relation to each other.

In addition, from the point of view of the final behavior, it is important how the stress is distributed and transferred between the layers in a multilayer structure, which is also affected by inter-layer adhesion, among other things. In addition, the contact resistance between the layers affects the final resistance. In any case, the multi-layer structures usually improve “fatigue resistance”, because the stress is distributed more evenly throughout the structure, and potential damage cannot progress to rupture as easily. Because of that, adding layers and/or increasing the material amount can also improve the tensile strength.

Even if the materials are blends and/or composites based on the same elastomer, from which a hybrid conductor structure is formed, there will inevitably be significant differences in the other properties of the material, in addition to conductivity.

For example, if the highly conductive layer tends to break down even with smaller stretches, then that insulating intermediate layer does not necessarily greatly increase the stretchability of the conductor and does not actually affect at all how the conductor behaves when stretched. For example, DS/ECLME and DS/EC7/ECLME both produce a similar response in stretching (shape of the curve), but the point where the conductor breaks is only moved further by the EC7 interlayer. On the other hand, if a 2PEC7 layer is used, then a whole new type of conductive material will be created, which does not resemble either material at all or the combination that can be deduced from them. In the latter case, the stress distribution is completely different.

Thus, even one intermediate layer can distribute the tension more evenly, and even dissipate strain within the structure. More than one intermediate layer can be included, but in such case predicting the final properties and electro-mechanical behavior of the multilayered structure becomes more complicated. Therefore, for most cases, one intermediate layer is enough to achieve a considerable performance improvement. However, preferably composition and/or material of each layer is different from the previous one, for example, the intermediate layer is different from the substrate layer. For example, in a multilayered structure consisting of substrate/EC7/2PEC7/ECLME, all the conductive layers are made on top of a layer based on the same base elastomer. In a multilayer structure consisting of substrate/2PEC7/ECLME, the 2PEC7 layer is made on top of the substrate, which is not based on the same base polymer matrix.

The properties of material, on top of which the next layer is deposited to, affects the final microstructure and/or morphology in the deposited layer during casting and solidification. In the case that the substrate material is not based on the same base polymer, the properties of the substrate change significantly (surface energy, contact angle, adhesion, surface roughness, porosity, etc.) and the interaction of chemical components in the solution can be different at the substrate/air-interfaces due change of the substrate material and/or its composition. Even if the base material is based on the same polymer matrix, the properties are still very different if the compositions are not completely identical.

The method may further comprise applying a third layer comprising a self-healing elastomer on top of the layer comprising a self-healing electrically conducting liquid metal elastomer composite. The applying may comprise any suitable applying method, such as printing, tape casting and/or the like. The third layer may be an encapsulating layer. The third layer may be applied onto an activated liquid metal elastomer layer, and it may encapsulate the conductive liquid metal elastomer composite layer, such as fully or partly encapsulate, and/or it may enhance the properties thereof. In one example the encapsulation layer is made of electrically conductive self-healing elastomer layer, such as a 2PEC7 layer, thus providing similar benefits to EC7 encapsulation layer, such as affecting the ultimate durability and electro-mechanical stability of the conductor. For example, if conductor structure made of 2PEC7/ECLME is compared to 2PEC7/ECLME/2PEC7, the overall performance does not differ significantly if a separate encapsulation layer is made of EC7 elastomer. However, if an encapsulation layer is not present at all, the difference can be substantial, for example, in terms of strain sensitivity and durability.

If electronics circuit is made, in which the components are connected to the ECLME surface, then it can no longer be encapsulated from the entire area with an electrically conductive self-healing elastomer layer (such as a 2PEC7 layer). This is assuming the absence of strong electrical anisotropy due to degree of phase-separation in the 2PEC7 blend film (i.e., the blend film is not completely insulating on the surface facing the circuit layer).

One of the advantages of using an electrically conductive self-healing elastomer layer, such as a 2PEC7, on top of the ECLME are that the surface mountable components can be strongly bonded to the interconnections as the adhesion properties of 2PEC7 can be adjusted more easily than in ECLME. Thus, the electro-mechanical stability of the interface between the component and interconnection can be significantly improved for both static and dynamic strains under large deformations. However, the additional conductive layer on top of the circuit layer and ECLME should then have almost the same geometry and dimensions as the ECLME layer, so that the circuit can still be fully functional without formation of short circuit.

In one embodiment the multilayer self-healing electrically conducting elastomer, i.e. the multilayer structure discussed herein, further comprises a third layer comprising a self-healing elastomer on top of the layer comprising a self-healing electrically conducting liquid metal elastomer composite. The third layer may be called as an encapsulating layer.

The multilayer self-healing electrically conducting elastomer film can be obtained with the methods disclosed herein.

### Self-Healing Electrically Conducting Liquid Metal Elastomer Composite

Disclosed is a self-healing electrically conducting elastomer composite, which is based on combination of liquid metal(s) with electrically insulative polymer/elastomer matrix, and a method for preparing thereof. The electrical and dielectric properties of the elastomer composite can be controlled with the volume of liquid metal(s) in the composite. The obtained soft, stretchable and autonomously self-healing liquid metal elastomer composites can restore, or even improve, their pristine tensile and electrical properties, and electrical conductivity under tensile strain after mechanical damage.

In general, addition of liquid metals provides several advantageous properties for soft matter, such as increased Young's modulus, improved toughness, notch-insensitivity, increased relative permittivity, increased dielectric breakdown voltage, increased thermal and/or electrical conductivity, electrical self-healing due to presence of oxide shell, capability of acting as hermetic barrier, such as to provide elastomers highly permeable to gases, for example water vapor, and a possibility for magnetic field control.

Because the other metals with low melting point are either toxic and/or highly radioactive, the only good option for forming the majority phase in liquid metal alloy is Ga. Especially if used in applications, such as soft electronics devices, that are in interfaced with the human body, living organisms or environment the challenges relating to application of gallium in products must be overcome.

The method for preparing self-healing electrically conducting liquid metal elastomer composite may comprise providing one or more liquid metals comprising gallium as main phase, such as a mixture comprising one or more liquid metals comprising gallium as main phase, in a solvent, such as in an organic solvent, in aqueous medium/water or a combination thereof. Gallium is a first liquid metal, and the mixture/alloy comprises one or more further metals including second (liquid) metal and optionally third (or further) (liquid) metal(s).

The liquid metal(s), or a mixture thereof, contribute(s) to electric (electrically conducting) phase of the elastomer composite. The electrical conductivity of the final elastomer composite can be controlled and/or adjusted by selecting suitable portion of the liquid metals in the final elastomer composite. A higher amount, such as more than 45% by volume of liquid metal(s), preferably 50% or more by volume, or more preferably 55% or more by volume, can provide an electrically conducting composite.

When gallium is used as the main phase of the liquid metal alloy it can provide effects such as high electrical conductivity in the range of (3.0-3.9)×10⁴ S cm⁻¹, high thermal conductivity of 19.2-29.5 W m⁻¹ K⁻¹, low viscosity in the range of (1.37-2.40)×10⁻³ Pas, high surface tension in the range of 533-718 N m⁻¹, low toxicity, negligible vapor pressure of less than 10⁻⁶ at 500° C., extremely wide temperature range from about 15° C. to about 2400° C. (the latter is the evaporation temperature), and negligible solubility in water.

The liquid metals may be provided as eutectic gallium-indium alloy comprising gallium and indium in Ga: In a ratio by weight of 68.3-99.0:1.0-31.7, preferably 73.0-78.0:27.0-22.0, such as 74.0-77.0:26.0-23.0, for example about 75.5:24.5.

In one example the method for preparing self-healing electrically conducting liquid metal elastomer composite comprises
providing gallium as a first liquid metal,
providing indium as a second liquid metal,
optionally providing one or more other liquid metal(s), such as tin,
mixing the liquid metals to obtain a mixture comprising liquid metal alloy comprising gallium and indium and/or wherein the liquid metals are provided as eutectic gallium-indium alloy comprising gallium and indium in a Ga: In ratio by weight of 68.3-99.0:1.0-31.7, such as 73.0-78.0:27.0-22.0, for example about 75.5:24.5.

As can be derived from experimentally derived phase diagrams for Ga—In system, the experimental melting point of Ga—In systems is between 15.7° C. to 30° C. when the amount of In is between 1.0-31.7% by weight. All these compositions are possible for mixing purposes with the present autonomously self-healing elastomers. In general, for the present purposes it is preferred to have a melting point of the liquid metal alloy of 30° C. or less, such as in the range of 5-30° C., for example in the range of 10-26° C.

Below are melting points (m.p.) of certain Ga-based metal alloys (given by weight ratios):
Ga₉₅In₅ 25° C.
Ga_{91.7}Sn_{8.3} 21° C.
Ga_{97.6}Al_{2.4} 25.9° C.
Ga_{96.1}Zn_{3.9} 24.7° C.
Ga₉₈Hg_{2.0} 27° C.
Ga_{96.4}Ag_{3.6} 26° C.
Ga₇₉In₂₁ 15.7° C.
Ga_{62.5}In_{21.5}Sn₁₆ 17° C.
Ga_{66.5}In_{20.5}Sn₁₃ 11° C.
Ga_{78.3}In_{14.9}Sn_{6.8} 13.2° C.
Ga₆₁In₂₅Sn₁₃Zn₁ 8° C.

A method for preparing a self-healing electrically conducting liquid metal elastomer composite may comprise
providing a mixture comprising liquid metals with gallium (Ga) as main phase, preferably in an organic solvent,
treating the mixture comprising the liquid metals with ultrasound to form a first mixture (M1) comprising liquid metal microparticles and optionally functional fillers,
providing one or more components contributing as a polymer matrix of the elastomer composite,
adding the one or more components to the first mixture (M1), optionally providing the one or more components as a second mixture (M2) and adding the second mixture (M2) to the first mixture (M1), to obtain a third mixture (M3),
allowing reaction to take place in the third mixture (M3) to cure the third mixture to obtain a self-healing electrically conducting or dielectric elastomer composite comprising
an elastomer matrix, preferably comprising a polymer blend with one or more electrically insulating phase(s) having a phase-separated structure with localized heterogeneity, and
55-90% by volume of liquid metal microparticles comprising gallium as main phase.

The obtained self-healing electrically conducting liquid metal elastomer composite, which may be present as a film or a layer, such as a multiphase film/layer, may comprise
a polymer matrix, preferably comprising a polymer blend with one or more electrically insulating phase(s) having a phase-separated structure with localized heterogeneity, and
55% or more by volume of liquid metals comprising gallium as main phase.

It was found necessary to provide the liquid metal in the form of liquid metal microparticles (LMMPs), which term may include particles having a size in the micrometer and/or nanometer range. The method may comprise forming the microparticles by using a suitable method.

To form micro and/or nano-sized particles (MP), the bulk LM is broken down, and the reforming of interfacial oxides is used for separating the individual LM droplets from each other. The thin oxide layer in MP can be considered as an advantage when, e.g., mixed with polymers as the van der Waals and Coulomb forces enable improved wetting, and anchoring to the polymer phases at their vicinity. The smaller LM droplets also enable better processability (discussed above) which is particularly important for enabling fabrication of soft electronics or alike.

The microparticles may be obtained by treating the bulk liquid metal alloy/mixture with suitable disintegrating method. The microparticles may be formed and are present in a suitable solvent. The microparticles may refer to micro and/or nanoscale particles, and they may have an average particle diameter of 100 μm or less, such as 50 μm or less, for example in the range of 100 nm-100 μm. In one embodiment the formed microparticles have an average particle diameter in the range of 100 nm-50 μm, such as in the range of 100 nm-30 μm.

The method may comprise treating the mixture comprising the liquid metals with ultrasound, i.e. ultrasonicating the mixture, to form a first mixture (M1) comprising microparticles containing liquid metals, microparticles consisting of liquid metals, and/or liquid metal microparticles. The first mixture may comprise one or more (functional) fillers, which may be dispersed in a solvent, such as in an organic solvent, in aqueous medium or combination thereof, or one or more fillers may be added to the first mixture. The fillers may be added to the liquid metals, to the first mixture (M1), and/or to any further mixture and/or at a further method step.

Ultrasonication was found to be an extremely effective strategy to decrease the MP size from hundreds of micrometers to few micrometers, or even less than that, such as down to tens of nanometers, especially if coupled with laser irradiation. In this method, the liquid metal is completely immersed in a liquid medium, which may comprise or consist of a suitable solvent, such as organic solvent and/or aqueous medium.

The method for preparing self-healing electrically conducting liquid metal elastomer composite comprises providing and/or forming an elastomer matrix for the liquid metal elastomer composite. The matrix may be called, and/or it may act, as an electrically insulating phase of the elastomer composite. The matrix may be bimodal.

The method for preparing self-healing electrically conducting liquid metal elastomer composite may comprise providing one or more components A, B contributing to an electrically insulating phase and/or an elastomer matrix of the elastomer composite. In one example the method comprises separately providing two or more components contributing to the elastomer matrix and/or to the electrically insulating phase of the elastomer composite. This may be the case for example if one or more matrix components are provided as a two-component system, or as a system comprising more components, for example Components A and B used in the examples. The elastomer matrix may be also called a matrix and/or a polymer matrix. The components may comprise one or more compounds and/or a mixture or a combination of two or more compounds. Similar elastomer matrices may be used in the other layers, which do not include liquid metal.

### Methods for Preparing Elastomers

To prepare the self-healing elastomers and layers comprising the self-healing elastomers, a suitable self-healing elastomeric matrix is provided and/or formed. The matrix may comprise an interpenetrating (elastomer/polymer) network. The terms “interpenetrating network”, or “interpenetrating polymer network”, or the like as used herein refers to materials comprising two or more networks which are at least partially interlaced on a polymer scale but not covalently bonded to each other. The network cannot be separated unless chemical bonds are broken. In the final product the elastomers/polymers in the matrix may form a phase-separated structure with localized heterogeneity.

The terms “intrinsic self-healing” or “intrinsically self-healing” or the like, which are properties of the present materials, refer to the build-in, inherent self-healing ability of a material. Usually, reversible chemical bonds are involved within the material.

The terms “autonomous self-healing”, or “autonomously self-healing”, or the like, which are properties of the present materials, refer to the ability to initiate the self-healing process without external intervention. External intervention may be a temperature change to higher than the room temperature, such as 30° C. or more, and/or other stimuli such as pressure, chemicals, humidity, moisture, etc. External intervention may also be a force to be applied to initiate self-healing, e.g. when aligning cut/fractured surfaces, regardless of temperature. Thus, an autonomous self-healing material can heal without intervention at any given room temperature, such as 0-30° C.

The term “universal self-healing”, or the like, which is a property of the present materials, refers to the self-healing ability in not only ambient conditions, but also various other conditions, such as at frozen, even temperatures down to −140° C., under water, and/or the like.

One example of a method for preparing self-healing elastomers comprises adding the one or more components A, B to the first mixture (M1) to obtain a third mixture (M3).

In one example the method the one or more components contributing to the electrically insulating phase and/or the matrix of the elastomer composite are provided as a second mixture (M2). The second mixture (M2) may be combined with the first mixture (M1), such as added to the first mixture, and preferably mixed, to obtain a third mixture (M3)

The method comprises allowing reaction(s) to take place in the third mixture (M3) to set/cure the third mixture to obtain the self-healing electrically conducting or dielectric elastomer composite. The method may comprise adding one or more components including a crosslinking agent to the third mixture (M3).

There are several suitable methods for making the electrically conductive liquid metal elastomers and other elastomers discussed herein.

### Step 1—Choosing the Elastomer Matrix for Elastomers and Composites

The selection of elastomer and its compositions, in terms of used fillers, depends on the type and location of elastomeric layer required in the multilayered structure, The tensile and self-healing properties of the elastomer blends and composites are highly dependent on the choice of the elastomer matrix to which other additives such as functional fillers may be added.

The elastomer matrix may comprise a first phase, such as a soft (softer) phase, and a second phase, such as a hard (harder) phase, and they may be bimodal, and have interpenetrated structure. Thus, the first phase may be physically softer (i.e., having a lower Young's modulus) than the second phase. The elastomer can also exhibit a phase-separate structure with localized heterogeneity.

One preferred option is to use polysiloxane-based elastomers in the matrix, which were found advantageous for providing autonomously self-healing elastomer composite materials. The elastomer may be supplemented with boron dioxide, preferably in form of nanoparticles.

Such self-healing elastomers have a unique structure formed by the interpenetrating networks, cross-links and a unique composition, that contribute unprecedented mechanical properties. The self-healing elastomer is capable of being stretched more than 20 times of its length and return the original size and form with the original or even better mechanical properties. The present elastomers show enhanced polymer chain flexibility at a very wide range. Further, the self-healing elastomer possesses all in one excellent elasticity, autonomous self-healing efficiency, moisture barrier ability, and transparency, which properties are difficult to achieve simultaneously in the known single material of the prior art.

In one example a composition of a non-conductive, interpenetrated, bimodal poly(dimethylsiloxane)-based self-healing elastomer may be defined by one or more of:
amount of hydroxyl-terminated polydimethylsiloxane (PDMS-OH)
boron trioxide nanoparticles (B₂O₃ NPs)
   and forming the soft phase in the bimodal elastomer;
amount of polysiloxane precursors comprising siloxane base and crosslinker in relation to one other
   and forming the hard phase in the bimodal elastomer;
amount of soft phase in relation to the hard phase.

The PDMS-OH may have a kinematic viscosity in the range of 850-25000 cSt, preferably 18000-22000 cSt, at 25° C. A rheometer, such as Haake Mars 40, can be used for determining the kinematic viscosity with measurement standard ASTM D2196-20. It was found that using PDMS-OH having a lower kinematic viscosity, i.e. PDMS-OH having low molecular weight, such as 850-1150 cSt, results a softer final elastomer regardless of the other processing conditions. By increasing the kinematic viscosity of PDMS-OH used, it was found out that the elastomer becomes increasingly more robust as elastic modulus (E) and stress at break (δ_{break}) increase by over 10-fold. As the molecular weight of the precursor increased, both the stress at break and strain at break significantly increased due to the number of entanglements increasing. Regardless of the processing conditions or composition, the polymer strength and extensibility should increase with viscosity of PDMS-OH.

The amount of PDMS-OH used has an impact to the self-healing ability of the final product, i.e. the self-healing elastomer. To achieve sufficient self-healing ability while maintaining good mechanical properties of the self-healing elastomer, the amount of PDMS-OH used may be 65-90% by weight of the final product.

The method utilizes a multiphase strategy, where the idea is to take advantage of the soft and hard phases in the elastomer matrix. In this case, the soft phase allows intrinsic self-healing, i.e. dynamic interactions, while the hard phase adds material rigidity and mechanical strength, as well as allows viscoelastic nature of material and material conversion to elastomer (due to entropy-driven elasticity). The first composition (A) and the second composition (B) disclosed herein contribute to the hard phase after curing, so the hard phase in general may be a reaction product of polysiloxane precursor and a crosslinking agent. The soft phase may be a reaction product of B₂O₃ and PDMS-OH. The multiphase elastomer matrix, which may represent an electrically insulating phase, thus preferably comprises a soft phase and a hard phase, and a phase-separated structure with localized heterogeneity.

In one example the one or more components comprise hydroxyl-terminated polydimethylsiloxane (PDMS-OH), boron trioxide (B₂O₃), and polysiloxane precursors comprising a siloxane base (A) (first composition (A)) and a crosslinking agent (B) (second composition (B)), and
adding the hydroxyl-terminated polydimethylsiloxane (PDMS-OH) to the first mixture (M1),
providing the boron trioxide (B₂O₃) and the siloxane base (A) as a second mixture (M2),
combining the first mixture (M1) and the second mixture (M2), and preferably mixing,
adding the crosslinking agent (B). A third mixture (M3) is formed. As the crosslinking proceeds, the third mixture is crosslinked, cured and/or set, and the elastomer composite is formed.

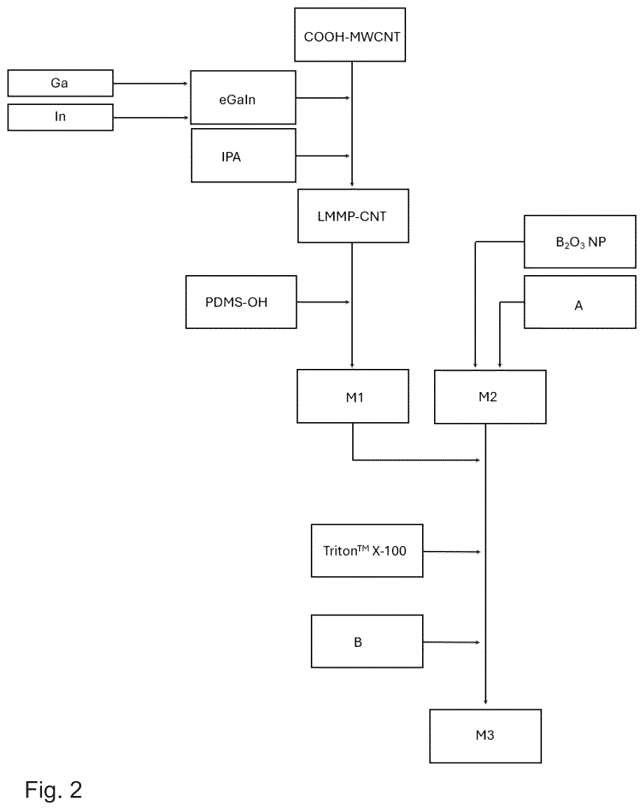

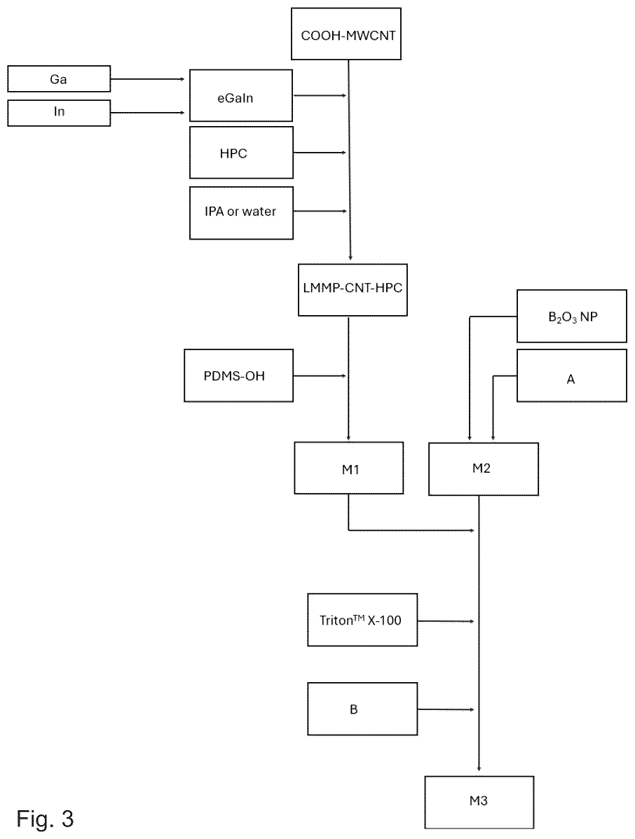

The crosslinking agent may be also called as a curing agent. “A” and “B” in the present description and in FIGS. 2-4 refer to Component A (first composition A) and to Component B (second composition B, crosslinking agent), or a mixture or composition comprising thereof, which components may be added in the method. Component A comprise one or more polymer bases, such as a silicone-based polymer, for example a siloxane base. Component B comprises one or more curing or crosslinking agents, preferably compatible with Component A, such as a siloxane crosslinker. Examples of Components A and B can be obtained commercially as Sylgard™ 184 silicone elastomer kit. When the liquid components are thoroughly mixed, the mixture cures to a flexible elastomer, for example polydimethylsiloxane (PDMS), which may be vinyl-terminated in the case of Sylgard™ 184. The ratio by weight of Component A and Component B may be in the range of 1:1-50:1.

Morphological changes in the elastomer matrix were experimentally confirmed from AFM phase images the, for example, degree of phase separation, upon the change of the added crosslinking agent (B) in the hard phase. The vertical phase-separation is important for the entropic recovery of properties due to increasing free volume as the phase separation increases. The phase-separation increases with the increase of added crosslinking agent (B) in the hard phase.

The boron trioxide may be provided and/or be present as, or in the form of, boron trioxide nanoparticles (B₂O₃ NP). The nanoparticles have an average diameter at a nanoscale range, such as an average diameter of 500 nm or less, such as 200 nm or less, for example in the range of 1-500 nm, such as 50-200 nm, preferably 80-100 nm, measured microscopically, for example by using electron microscopy, such as SEM.

In example the B₂O₃ is provided or is present in an amount of 0.40-3.00% by weight, preferably 0.65-1.90% by weight, and more preferably 0.75-1.40% by weight, for example about 0.85% by weight.

It was found out that the presence of B₂O₃ nanoparticles provides a large contacting area for the reaction and thus contributing to the reaction efficiency significantly, when compared with non-nanoparticles of B₂O₃. Thus, in the case of using B₂O₃ nanoparticles, less B₂O₃ is needed. It was also found out that the amount of B₂O₃ used affects the mechanical properties in the product, i.e. the resulting self-healing elastomer. Thus, by adjusting the amount of B₂O₃ a variety of products having different mechanical properties according to the practical applications can be achieved. Increasing amount of B₂O₃ can be beneficial to a certain extent in the multiphase elastomer as the number of cross-links can be increased, because there is B₂O₃ nanoparticle residue left in the final product.

The intermediate product produced by reacting B₂O₃ and PDMS-OH has a surprisingly large amount of dynamic bonds, or dipole-dipole interactions, that contribute to the intrinsic self-healing ability. The supramolecular dynamic bonds, such as hydrogen bonds and dative bonds between boron and the oxygen in the Si—O groups, allow self-healing ability to be maintained without deterioration over time.

The boron trioxide nanoparticles are present in the final product, i.e. the boron trioxide nanoparticles are not solved or otherwise disintegrated below detection level and can be detected microscopically. The products prepared by the present methods can be identified by simple optical methods, such as under optical microscopy or using UV-vis NIR spectroscopy.

The properties of the elastomer matrix can be further adjusted and controlled by adding one or more of surfactant(s), and amount of the surfactant(s) in relation to the elastomer components, and/or so-called one-dimensional fillers, such as any type of nanotubes, nanofibers, nanowires, nanorods, and/or nanofilaments. “One-dimensional” in general refer to fillers that have one of their dimensions less than 100 nm, such as less than 50 nm or 10 nm. As used herein they may refer also to materials having elongated structure, wherein the (average) thickness or diameter of the material is at nanoscale range, such as in the range of few nanometers, for example 0.5-5.0 nm, or 0.5-2.0 nm.

Especially when the amount of the liquid metal in electrically conductive liquid metal elastomer composites increases, the homogeneity of the composite can be greatly improved by using fillers, such as carbon nanotubes. It was demonstrated and evidenced by SEM images that the addition of carbon nanotubes prevents the agglomeration of liquid metal particles when present in a large portion, and also enables even distribution of the particles in the composite. This is important when it is desired to obtain homogenous materials. However, the carbon nanotubes also have an impact to the electrical and dielectric properties of the elastomer composite even at small volume, which has to be taken into account. Carbon nanotubes may be provided in the range of 0.5-5.0% by weight of the total elastomer composite. However, smaller amounts may be preferred to avoid decrease of electrical conductivity and more limited stretching range, such as in the range of 0.5-2.0% by weight, 0.5-1.5% by weight or preferably 0.5-1% by weight, even 0.5-0.9% by weight.

### Functional Fillers

The present self-healing elastomer composites and layers comprising thereof can be prepared and provided without additional fillers or with additional fillers. The fillers may include for example cellulose, derivatives thereof and/or cellulose nanomaterials and/or other nanomaterials. The functional fillers were found to improve properties of the conductors, such as stretchability and self-healing properties as well as conductivity, depending on the filler type.

One or more surfactants and/or fillers may be added or included. The addition of surfactants and/or one-dimensional nanofillers will influence the final properties of elastomer, such as stretchability, Young's modulus, toughness, resilience, rate and efficiency of self-healing, long-term structural stability. Generally, surfactants have plasticizing effect to the elastomer, thus, e.g., the material becomes softer and polymer chain mobility increases leading to better self-healing (but in some cases at the expense of mechanical properties and dimensional stability of the material). Addition of one-dimensional nanofillers have opposite effect for the bimodal self-healing elastomer. They not only increase the strength and Young's modulus, but the material becomes more dimensional stable (i.e., better creep resistance) and elastic.

The amount of functional fillers in a final composite or in a layer may be more than 0.01% by volume, more than 0.05% by volume or more than 0.10% by volume, such as in the range of 0.01-5.0% by volume, such as 0.01-2.50% by volume, for example 0.10-1.50% by volume or 0.1-1.0% by volume, and/or in the range of 0.01-5.0% by weight, 0.1-5.0% by weight, 0.5-5.0% by weight, 0.10-2.5% by weight, 0.5-2.5% by weight or 1.0-2.5% by weight.

### Cellulose and Cellulose Derivatives

Cellulose has linear, fibrous microstructure, where glucose monomers are linked together by the β(1→4) glycosidic bonds. Cellulose and derivatives thereof, such as hydroxyethyl cellulose, hydroxypropyl cellulose, and carboxymethyl cellulose, can be used as rheological modifiers in pastes or inks used for preparing the present layers, and can, for example, help to adjust the viscosity of the solution by thickening, and by improving the flow of ink due to their intrinsic shear-tinning behavior. A higher molecular weight cellulose is made of longer polymer chains that often results in stronger thickening of the solution due to the number of chain entanglements increasing.

Generally, a water is preferred aqueous medium as the cellulose derivatives have high affinity for water due by the large number hydroxyl groups (—OH) which form hydrogen bonds with water molecules (not only limited only to water, but possible also for with other functional groups in the solution). For example, the amphiphilic nature of hydroxypropyl cellulose (HPC) molecules allows them to interact also with each other through hydrophobic interactions. When dispersed in water, hydrophobic regions of the polymer chains tend to minimize their contact with the water molecules to reduce the free energy of the system. This drives the self-assembly of HPC molecules into well-ordered structures, where the hydrophobic regions are covered from the water and hydrophilic regions are exposed. As evident, the solution with water and cellulose becomes thicker than by replacing the water with other solvent. However, addition of water to the combined mixture (with elastomer components) is generally not preferred, thus controlled amount of HPC/CNT/water-mixture is added at the final step in the process.

HPC can interact with other phases in the system. For example, the polymer chains of HPC can become entangled with each other, and with the LMMPs leading to physical interactions. The hydroxyl groups in HPC can also form hydrogen bonds with the surface oxide layer and carboxyl groups in MWCNT-COOH, thus facilitating adsorption. The presence of HPC can also prevent agglomeration of MWCNT-COOH by providing steric hindrance or electrostatic repulsion between individual CNTs. Thus, HPC acts as a binder that tends to form encapsulation shell around the LMMPs, and therefore also results in stronger segregation of LMMPs in the 3D elastomeric network. This results in interesting electrical property behavior under mechanical strain with the ECLME and significantly improves the electrical conductivity after laser sintering. For example, the cellulose encapsules around LMMPs can break during stretching, which leads to controlled leakage of LMMP within the ECLME.

In one embodiment the cellulose comprises cellulose derivative, which may be selected from hydroxyethyl cellulose, hydroxypropyl cellulose, carboxymethyl cellulose and any combination thereof. The cellulose derivative may be soluble in water at room temperature and/or at temperatures discussed herein. The cellulose derivative can have an effect to the electrical properties, such as it can enhance the electrical conductivity. In one example the amount of cellulose derivative, such as HPC, in the aqueous mixture is 10-25% by weight, which was especially found to enhance the conductivity of the final films. In the final films the amount of cellulose derivative may be in the range of 0.10-2.5% by weight, such as 0.5-2.5% by weight or 1.0-2.5% by weight. This however depends on the total amount of liquid metal, the amount of solvent and/or water in relation to elastomer compounds and liquid metal, and/or the amount of added cellulose derivative to the mixture at the end.

### Nanomaterials

Nanostructured and/or nanoscale materials that can be used as functional fillers include carbon nanomaterials and other nanomaterials, such as carbon nanotubes and dots, graphene, (reduced) graphene oxide, nanolayers selected from graphite; metallic nanowires and (oxide) nanoparticles, layers and compounds compromising of thin layers of transition metal carbides, nitrides, or carbonitrides, such as MXene; organic nanoparticles, nanofibrils and nanorods and other one-dimensional nanomaterials; fullerenes and the like. In addition to nanomaterials, low molecular weight organic small molecules can be also used. Carbon nanotubes were found especially preferred for the present liquid metal elastomers and electrically insulating elastomer substrates.

In one embodiment the method comprises providing nanostructured and/or nanoscale materials, such as carbon nanotubes, and/or cellulose, such as cellulose derivative, as functional fillers, and incorporating the nanostructured and/or nanoscale materials and/or the cellulose to surface of the substrate, to a layer comprising self-healing elastomer, such as to the second layer comprising a self-healing electrically conducting elastomer and/or to the layer comprising a self-healing electrically conducting liquid metal elastomer composite.

In one embodiment the multilayer self-healing electrically conducting elastomer film comprises nanostructured and/or nanoscale materials, such as carbon nanotubes, and/or cellulose, such as cellulose derivative, as functional fillers on surface of the substrate, in a layer comprising self-healing elastomer, such as in the second layer comprising a self-healing electrically conducting elastomer and/or in the layer comprising a self-healing electrically conducting liquid metal elastomer composite.

The addition of homogenously distributed functional fillers, such as CNTs, decreases the self-healing rate while simultaneously improving the dimensional stability and creep resistance of the self-healing elastomeric network(s). Generally, after addition of small amount of CNT (about 0.1-0.4% by weight), the full recovery of the properties, after mechanical damage, via self-healing can take several days in comparison to just one hour in the ambient conditions.

The changes in the self-healing properties dimensional stability and creep resistance can be explained as following:

Homogenously distributed CNTs create a torturous path for the diffusion of moisture and oxygen molecules, thus increasing diffusion length and reducing permeation rates within the 3D elastomeric network. The high aspect ratio CNTs and entangled network structure leads to improved interfacial bonding as the CNTs can effectively interact with the polymer chains through hydrogen and coordination bonding. Both types of bonding prevent detachment and/or slippage of polymer chains at the interfaces as CNTs can effectively restrict the movement of polymer chains and reduce the diffusion. More importantly the carboxyl groups (—COOH) can provide additional sites for the interaction and the effective cross-linking density increases, which results in better integrity of the dynamic cross-links by further limiting their reversible breakage or rearrangement. The stabilization of the dynamic cross-links reduces the overall mobility of polymer chains and decreases polymer chain diffusion within the elastomer network resulting in exceptionally good long-term dimensional stability and creep resistance.

### Effect of Amphiphilic Surfactant for the Autonomously Self-Healing Elastomers:

Using an amphiphilic surfactant, such as Triton™ X-100, can have several benefits for the autonomously self-healing elastomer, especially if added in small quantities. However, there are several considerations that first need to be made when the long-term microstructural stability, elasticity, and creep resistance are important.
(i) All surfactants act as plasticizers causing the glass temperatures to decrease; thus, flexibility and mobility of the polymer chain further increases. In amphiphilic surfactants, the hydrophobic and hydrophilic moieties can also disrupt the cross-linking density in the polymer when the surfactants preferentially localize at the interfaces, or within the polymer chains. This can reduce the effective number of cross-links and can weaken the physical integrity of the 3D elastomer network. For example, by forming the weak interfacial region and disrupting the continuity of the microstructure within the elastomer. This results in increased the diffusion of the polymer chains and introduces a high creep and poorer elasticity under large deformations.
(ii) Surfactants are known to undergo a migration or redistribution within 3D elastomer network over time as the surfactant molecules can diffuse along the microstructure. The redistribution of the molecules can disrupt the equilibrium of interactions between polymer chains and cross-links leading to further polymer chain diffusion and dimensional instability.
(iii) The hydroscopic nature of the surfactant can contribute to the plasticizing effect and promote the diffusion polymer chains due to the moisture sensitivity of Si—O:B bonds in the bimodal elastomer. The absorption of moisture and water molecules can induce significant dimensional instability especially if the elastomer is under continuous, dynamic or static mechanical loadings.

The self-healing elastomers can be prepared with the following exemplary methods, either without adding a filler and/or other additives, or by adding one or more fillers, surfactants and/or any of the other additives disclosed herein.

In one example a method for preparing a self-healing elastomer comprises providing one or more components by providing separately the following components, the percentages referring to the total weight of the elastomer matrix (electrically insulating phase):
0.1-5% by weight of boron trioxide (B₂O₃), preferably as nanoparticles having a number-average diameter in the range of 50-200 nm, preferably 80-100 nm, measured microscopically, for example by using electron microscopy, such as SEM, and
65-90% by weight of hydroxyl-terminated polydimethylsiloxane (PDMS-OH)
5-30% by weight of polysiloxane precursors comprising
   a first composition/component (A) comprising a siloxane base, and
   a second composition/component (B) comprising a siloxane crosslinker, preferably wherein the ratio by weight of the first composition/component (A) to the second composition/component (B) is 1:1 to 50:1,
combining the B₂O₃, the hydroxyl-terminated polydimethylsiloxane, optionally one or more surfactants (S1), the polysiloxane precursors and the first mixture (M1), thereby obtaining the third mixture (M3),
reacting, such as allowing reaction to take place in, the third mixture (M3) to set/cure the third mixture, preferably at an elevated temperature in a range of 50° C.-150° C., to obtain the self-healing elastomer composite.

One example provides a method for preparing a self-healing elastomer composite, the method comprising providing
0.1-5% by weight of boron trioxide ((B₂O₃), preferably as nanoparticles
65-90% by weight of hydroxyl-terminated polydimethylsiloxane (PDMS-OH)
5-30% by weight, when measured in combined, of polysiloxane precursors, being
   first composition/component (A) comprising a siloxane base, preferably a polymer containing at least one ethylenically unsaturated group, and preferably also a branched siloxane-based polymer, and optionally a surface modifier which preferably contains at least one ethylenically unsaturated group; and
   a second composition/component (B) comprising a siloxane crosslinker,
      where the ratio by weight of the first composition and the second composition is 1:1 to 50:1;
combining, such as homogeneously mixing, B₂O₃, PDMS-OH, and the first composition, thereby obtaining a mixture,
reacting the mixture and the second composition at an elevated temperature in a range of 60-150° C., to obtain the self-healing elastomer composite.

Polymer chain length has an effect to the properties of the matrix and the elastomer composite. The effective amount of net/junction points (or “cross-links”) increases as the length of the polymer chains increases as the strands occupy “larger” three-dimensional space in a state of the highest conformational entropy (that is without stress).

As the molecular weight of the precursor is increased, both the stress at break and strain at break of the elastomer matrix significantly increased due to the number of entanglements increasing.

By increasing the proportion of the second composition (B), the cross-linking structure of the elastomer matrix increases, thus leading initially at larger phase separation, for example when ratio changes from 10:1 to 5:1.

An elastomer may comprise or be poly(3,4-ethylenedioxythiophene) polystyrene sulfonate (PEDOT:PSS) based elastomer or a composite comprising thereof. PEDOT:PSS is a polymer mixture of two ionomers. One component sodium polystyrene sulfonate and part of the sulfonyl groups thereof are deprotonated and carry a negative charge. The other component poly(3,4-ethylenedioxythiophene) (PEDOT) is a π-conjugated polymer and carries positive charges and is based on polythiophene. Together the charged macromolecules form a macromolecular salt. PEDOT:PSS contributes to the electrical conducting phase of the elastomer. Also, under the effect of a solvent, the formed PEDOT-rich nanofibrils may simultaneously improve all mechanical properties of the elastomer, such as strength, toughness, extensibility, and temperature and/or speed-induced toughening, and self-healing characteristics through increased diffusivity.

To prepare PEDOT:PSS, a first mixture may be obtained by preparing an aqueous dispersion comprising PEDOT:PSS, adding the solvent into the aqueous dispersion, thereby obtaining a mixture, and drying the mixture, thereby obtaining the first mixture. During drying, the solvent opens up the insulating PSS shell covering conductive inner domain, and then coalescences PEDOT:PSS microgel particles by facilitating a transition from coiled core-shell structure to linear long chains, which can form larger crystalline PEDOT-rich domains and leads to interchain entanglements between PSS chains during processing. This improves the electrical conductivity of the material elastomer. The amount of the solvent may be up to 50% by volume based on the volume of the aqueous dispersion, or up to 32% by weight based on the volume of the aqueous dispersion.

Formation and interconnection between PEDOT-rich nanofibrils and density of the network can be significantly improved by particularly higher amounts of solvent, for example 12% by volume or more, which maintains the linearity as the amount of the isolate phase increases. It is observed that a higher content of the solvent facilitates a better conductivity and self-healing properties.

One example provides a method for preparing a self-healing elastomer (composite), the method comprising
providing a first mixture comprising PEDOT:PSS and a solvent, said first mixture contributing to an electrically conducting phase of the elastomer,
providing separately following components, which contribute to an electrically insulating phase of the elastomer, based on the total weight of the electrically insulating phase:
0.1-5% by weight of boron trioxide (B₂O₃), preferably in the form of nanoparticles,
65-90% by weight of hydroxyl-terminated polydimethylsiloxane (PDMS-OH)
5-30% by weight, when measured in combined, of polysiloxane precursors 201, being
a first composition comprising a siloxane base, preferably a polymer containing at least one ethylenically unsaturated group, and preferably also a branched siloxane-based polymer, and optionally a surface modifier which preferably contains at least one ethylenically unsaturated group;
a second composition comprising a siloxane crosslinker, wherein the ratio by weight of the first composition and the second composition is 1:1 to 50:1;
mixing the B₂O₃, the PDMS-OH, the first composition, the second composition, a surfactant, and the first mixture, thereby obtaining a second mixture,
allowing reaction to take place in the second mixture by setting the second mixture at an elevated temperature in the range of 50-150° C. to obtain the elastomer. Said reaction involves solidification, and the obtained elastomer is solidified elastomer.

The solvent may be an organic solvent, preferably a polar solvent, for example sugar alcohols, sulfoxides such as dimethyl sulfoxide (DMSO), ethylene glycol (EG), tetrahydrofuran (THF), or glycerol. The solvent O1, acting as secondary dopant, in the mixture comprising PEDOT:PSS transforms the PEDOT:PSS micelles into nanofibril in which the conducting PEDOT chains are better interconnected. Secondary dopants do not directly increase the number of charge carriers in the π-conjugated polymer as dopants do in metals or intrinsic semiconductors. Aqueous colloidal dispersion forms micellar microstructure with hydrophobic PEDOT-rich core and hydrophilic PSS-rich shell, i.e. PSS chain coiled around PEDOT core. This type of tertiary structure is known to be the origin of poor conductivity in pristine PEDOT:PSS films. Basically, PSS adds counter-ion and soluble template that improves chemical stability and solubility of PEDOT in aqueous solutions. The PSS chains are swollen in water. The PEDOT and PSS are held together by ionic interaction, which can be weakened with secondary dopants leading to, for instance, coalescence of microgel particles and phase-separation between PEDOT and PSS upon solidification.

Alternatively, the solvent may further comprise a water-soluble compound comprising acidic anions, such as ionic salt such as lithium bis(trifluoromethanesulfonyl)imide (LiTFSI), to further increase the conductivity. Ionic compounds that contain sulfonate or sulfonimide anions are known dopants for π-conjugated polymers, such as PEDOT:PSS. The compounds should have good water solubility (and thus to PEDOT:PSS), and contain acidic anions (for charge transfer doping). Therefore, LiTFSI is a particularly good option due to its excellent water solubility. It is found that in such a case, the solvent shall not be an organic solvent (such as DMSO) as it leads to microgel particle aggregation, thus formation of flakes. Thus, the solvent O1 may be, for example, comprising LiTFSI dissolved in deionized water. The amount of ionic salt can be as low as, for example, 50 mg with 100 mg DI water for about 2.3 g of the aqueous dispersion comprising PEDOT:PSS. Such modification increases the anisotropic electrical conductivity nearly two-fold to range of about 1.4-2.0 S cm⁻¹ (in comparison to that with 13% by weight or 16% by volume of DMSO). It is proposed that even higher amount of ionic salt can be added, and the conductivity would then increase with the amount of ionic salt increasing. Dopants may convert higher portion of benzoid moieties in PEDOT to quinoid structure through oxidative charge transfer doping resulting in more planar backbone which then contributes to charge delocalization and higher packing order (i.e., leading to better charge transport). At the same time these ionic compounds can act as plasticizers and promote morphology changes (formation of fibrous morphology) leading always to enhanced stretchability and decreased Young's modulus in the conductor, but also in some cases better self-healing characteristics if the proposed material fulfils the intrinsic requirement for self-healing of having a stimuli-responsive component or network (i.e., has the ability to initiate self-repair cycle) (similar to addition of DMSO). The main idea of plasticizers is to reduce the glass transition temperature by increasing free volume. This will induce morphological changes, such as relaxation of polymer chains, and may allow formation of more interconnected network of PEDOT-rich chains. With plasticizer the material becomes less stiff and more deformable, while it can promote self-healing characteristics by changing localized chain flexibility and glass transition temperatures.

The surfactant is preferably an amphiphilic surfactant, more preferably a nonionic surfactant, for example polyethylene glycol tert-octylphenyl ether (Triton™ X-100). The amphiphilic surfactant weakens, inter alia, ionic interaction between conducting PEDOT and insulating PSS, causing phase separation and enhancing crystallization of PEDOT segments (similarly to secondary dopants). The amount of the surfactant may be at least 0.1% by weight, for example up to 15% by weight, based on the weight of the aqueous dispersion. It has been surprisingly found, that the amount of surfactant has no effect on electrical conductivity, in forming the second mixture M2; regardless of the amount of surfactant, electrical conductivity is similar with similar processing parameters and composition. However, it has also been surprisingly found, that a higher amount of the surfactant improves the overall stability of the final product, in terms of mechanical and electrical properties in ambient conditions with different levels of humidity, due to the more interconnected hydrophobic and hydrophilic domains due to amphiphilic nature of the surfactant. With smaller amount of surfactant present, such as 1.0-1.5% by weight, for example about 1.3% by weight, the diffusivity and moisture sensitivity were significantly higher. This means that a conductor made with less amount of surfactant, such as about 1.3% by weight, becomes significantly softer underwater (in comparison to its dry state at elevated temperatures), but the conductor with a high content of surfactant, such as 10-15% by weight, for example about 13% by weight, may remain stiffer. This similar effect is seen at ambient conditions when a conductor is exposed to ambient humidity. A conductor with less surfactant, such as about 1.3% by weight, may considerably soften within a few minutes (dependent on the actual temperature and humidity present). However, a conductor with more surfactant, such as about 13% by weight, maintains its dry state properties significantly longer. Also, the effect of humidity is not as significant when the exposure time is long enough to have an effect to the mechanical properties. Another function the amphiphilic surfactant is to allow PEDOT-rich nanofibrils to be homogenously dispersed into polyboronsiloxane before solidification. The surfactant reduces interfacial tension, i.e. force of attraction, and adsorbs at interfaces between conducting and insulating phase. Thus, it allows a blend of thermodynamically incompatible phases that will then eventually phase-separate through multiple interaction mechanisms and factors contributing to the final phase-separation in the multiphase system. Without amphiphilic surfactant, the π-conjugated polymer and the insulating self-healing phase cannot be mixed with each other. For example, since PEDOT is hydrophobic and the PSS is hydrophilic, when amphiphilic surfactant is directly added to PEDOT:PSS dispersion, the head of the surfactant attaches to PSS and tail to PEDOT, which can facilitate formation of nanofibrils (similar to DMSO), and in the case of multiphase material system contributes to the final morphology and structural formation by connecting hydrophobic and hydrophilic chain segments.

### Mixing

In the preparation of liquid metal elastomer composites, in a mixing phase, the first step is to prepare a liquid metal microparticle (LMMP) paste that can be mixed together with the elastomer components.

In examples, a specific amount of functional fillers, such as nanoscale and/or nanostructured fillers, including carbon nanotubes (CNT), for example carboxylic acid (COOH—) functionalized multiwalled carbon nanotubes (MWCNT-COOH), are added together with the LM and the solvent for the probe ultrasonication. When CNTs are used to form the LMMP with CNT (also referred to as “μLM-CNT”), isopropanol alcohol/isopropanol/2-propanol (IPA) was found to be a good solvent.

LM-CNT refers to liquid metal interconnected carbon nanotubes. LM-HPC refers to liquid metal (LM) interconnected hydroxypropyl cellulose (HPC). μLMMP-CNT refers to microparticles of the liquid metal interconnected carbon nanotubes. μLMMP-HPC refers to microparticles of the liquid metal interconnected hydroxypropyl cellulose. μLMMP-CNT-HPC refers to microparticles of the liquid metal interconnected carbon nanotubes and hydroxypropyl cellulose.

For the electrically conductive liquid metal elastomers (ECLME), the amount of LM needs to be above 45% by volume, such as 50% or more by volume, preferably 55% or more by volume, preferably up to 90% by volume, 85% by volume, 80% by volume or 75% by volume, such as in the range of 45-90% by volume, in the range of 50-85% by volume or in the range of 55-80% by volume. In one example the elastomer composite is electrically conducting elastomer composite comprising 55% or more by volume, such as 55-85% by volume, for example 60-80% by volume or 60-75% by volume, of an electrically conducting phase comprising gallium as main phase.

The amount of CNTs may be more than 0.01% by volume, more than 0.05% by volume or more than 0.1% by volume, such as in the range of 0.01-2.25% by volume, for example 0.1-1.50% by volume or 0.1-1.0% by volume. The same may apply to other functional fillers or combinations thereof.

It was experimentally shown that the added functionalized CNTs can stabilize the dispersion and prevent excessive precipitation after settling for a longer period of time. Also, the addition of the functionalized CNTs can improve adhesion of the LMMP to the elastomer matrix and to the substrate. The same applies to other nanoscale and/or nanostructured fillers, such as nanoscale and/or nanostructured carbon fillers.

In one example a specific amount of functionalized carbon nanotubes, such as COOH— functionalized multiwalled carbon nanotubes (MWCNT-COOH), and cellulose, such as hydroxypropyl cellulose (HPC), are added together with LM and the solvent for the probe ultrasonication. All additional fillers may be mixed with the probe ultrasonication at the start to prepare the LMMP with CNT and HPC (also referred as “μLM-CNT-HPC”, or “LMMP-CNT-HPC”).

In one example HPC is not added at the start and LM-CNT (or LMMP-CNT) is formed. HPC is mixed with solvent, and additionally CNTs can be added as well. However, the addition of CNT is optional in this method. If CNTs are added, they can be added at the start (to form μLM-CNT), to form M3, or in two parts when preparing both μLM-CNT and M3.

Finally, the obtained LMMP paste is mixed with the elastomer components. The LMMP paste may comprise or consist of solvent and LM with either CNT, cellulose, or both CNT and cellulose, and can be denoted as μLM-CNT, μLM-HPC, μLM-CNT-HPC (or as LMMP-CNT, LMMP-HPC, LMMP-CNT-HPC).

One example comprises providing carbon nanotubes and/or cellulose as functional fillers and adding the carbon nanotubes and/or the cellulose to a mixture comprising the liquid metals, such as to the mixture of liquid metals, to the first mixture (M1), to the third mixture (M3), to a fourth mixture (M4) and/or to two or more thereof, preferably before applying ultrasound and/or adding the curing agent (B). Other functional fillers and/or additives may be added in similar way.

Outcome of the methods disclosed in previous is usually a homogenous elastomer composite paste, that can be further used for example in additive manufacturing, film formation and/or in any other suitable method used for forming the shape or form of the product.

The rheological properties of the composite paste must be controlled to fit the chosen method by adjusting the composition and amount of solvent(s). For example, the viscosity is easier to control precisely with compositions that also include either carbon nanotubes or cellulose, or both carbon nanotubes and cellulose as a part of composite. With the use of these components, increasing the viscosity of the composite paste is also possible. Thus, the method may comprise providing one or more of the additives or fillers as a rheology modifying agent and/or in an amount capable of adjusting rheology, such as viscosity. The rheology may be adjusted and/or controlled to a suitable range and/or value, so that the obtained compositing/composite is suitable for the intended use, such as for use as or in any application disclosed herein, for example as a depositable, printable and/or spreadable paste or mixture, such as a paste, ink, solution, or other composition or form suitable for additive manufacturing, thin film depositions and/or other applicable use.

### Forming Layers or Films

The elastomer composite in the suitable form may be formed into a layer, which may be an intermediate liquid metal elastomer composite layer or a final layer. An intermediate liquid metal elastomer composite layer may need further processing, such as surface processing. In most cases the elastomer is formed into a film and/or into a coating on the surface. The term “film” used herein may also refer to a layer or a coating, which terms may be used interchangeably. The film or the coating may have a thickness in a broad range, such as in the range of 50 nm to 1000 micrometers, such as 50-100000 nm, 50-10000 nm, 50-1000 nm, 100-100000 nm, 100-10000 nm, or 200-2000 nm, depending on the preparation method, composition of the elastomer composite, intended application and/or the like. The examples and embodiments referring to films may be also applied to other forms of the elastomer composites, such as to coatings which are not completely freestanding layers and/or planar, for example formed onto substrates with non-planar surface. Patterns or other shapes deposited onto surfaces, substrates and/or other target materials, such as by additive manufacturing, printing or other methods, may be considered films or may represent other forms of the (final) products.

Thin film deposition, coating, casting, printing and additive manufacturing are examples of suitable methods for forming the product, shape and/or part thereof, for example for forming a film and/or a coating.

The self-healing elastomers and composites thereof may be printed, attached and/or deposited onto a substrate or other target material, such as onto another layer.

Shapes or patterns can be formed to the films and/or film structures during preparation and/or after preparation, for example the patterning may be obtained later with the degradative methods disclosed herein. For directly printing into desired shapes, various printing and/or additive manufacturing methods can be used, e.g., direct ink writing (DIW), stencil or screen printing, microcontact printing (μCP), gravure or flexography printing, or even inkjet printing. Generally, methods that are more suitable for viscous pastes/inks/solutions are directly more suitable for the ECLME elastomers without additional rheological modifications needed to adjust to the viscosity.

For preparation of uniform thin films there are various methods that are available. For example, tape casting, blade coating, slot-die coating, bar coating, or even spin or spray coating. Some of these methods allow patterning in-situ, and continuous films can be further patterned with laser ablation after casting.

Direct patterning of functional materials can be carried out with a variety of methods. Printing and additive manufacturing methods include direct ink writing (DIW), stencil printing, screen printing, microcontact printing (μCP), gravure printing, flexography and inkjet printing.

The direct patterning ECLME is possible, but not limited to, for example, direct ink writing (DIW), stencil or screen printing, microcontact printing, gravure or flexography printing, and inkjet printing. However, certain methods further comprise modifying the rheological properties

DIW is a micro-scale, computer-controlled, 3D printing technique where a viscous slurry is deposited to substrate, e.g., through a syringe with pneumatic pressure. The printing head and/or the platform can move in x-, y-, and z-directions enabling formation of two- and three-dimensional shapes. Generally, the printing thickness is influence by several factors, such as by viscosity, typically ranging from 10⁻¹-10³ Pa·s, or 10³-10⁶ cP, and shape retention ability of the slurry, deposition rate, surface energy and roughness of the substrate, i.e., thickness of deposited material increases proportionally. The DIW enables fabrication of complex three-dimensional structures that are built layer-by-layer, while multiple printing heads can be also combined to deposit various functional materials simultaneously enabling multimaterial printing for rapid prototyping and fabrication of soft electronics devices. Because in most 3D printing methods the printed layers need to be self-supporting, there will be limitations to composition of the composite, printing dimensions and speed. The overall printing resolution of DIW is usually more than several tens of micrometers.

The viscosity of the ECLME pastes/inks can be controlled easiest by selecting a solvent to be used with CNTs. For example, IPA produces thicker paste with CNT than toluene. Also, the amount of CNTs, and the amount of solvent can be controlled and/or adjusted. The solvent can be also added, e.g., to PDMS-OH before mixing them with another components; the solvent should have good compatibility with the elastomer components. IPA and toluene were found to work well.

Stencil and screen printing are one of the most widely used printing techniques for electronics manufacturing on soft substrates due to versatility and cost-effectiveness of the methods for rapid prototyping. In the methods, functional paste/ink is transferred onto substrate through either a fine mesh or mask template, such as shadow mask. For screen printing, the mesh count defines the printing resolution, thus, the minimum printing resolution is above tens of micrometers (with mesh counts in the range of 20-320). In screen printing, the dispersed particles in the functional material must be smaller than the used mesh opening. For stencil printing this does not matter as there is no mesh when using a mask with only the openings. The fine mesh is strained to a solid frame, and the mesh apertures transfer the functional paste/ink to the substrate when the squeegee is moved and pressed against the mesh. Depending on the mesh count, the viscosities of the functional paste/inks are in the range of 10⁻¹-10¹ Pa·s which are obviously lower than for DIW printing. The deposited thickness of the functional material is then dependent, e.g., on the mesh thickness (i.e., holds more paste/ink), mesh tension and applied pressure as it affects the contact to the substrate, and the number of passes. In comparison, for stencil printing, the main deciding factor for the thickness of the deposited functional material is mask thickness and viscosity of the solution. With screen printing, fine features and high-resolution patterns are cumbersome to achieve as the resolution is limited by the mesh count. Stencil printing can achieve finer features and better resolution as there is no mesh, and the masks can be made, e.g., with chemical etching, photolithography, or laser ablation. However, because the thickness of the deposited layer is mostly dependent on the mask thickness, deposition of thin layers can be difficult. In general, the mask should be rigid and made of material with high Young's modulus to avoid any mechanical deformation during the printing to achieve a good quality (especially when printing onto soft matter).

μCP is high resolution, sub-micron scale printing technique where functional material is deposited onto patterned stamp, or master mold, which is then used to transfer the pattern to target material. The method is especially advantageous if functional materials need to be directly patterned on complex, non-planar 3D surfaces made of soft and elastic materials. The thickness of the deposited functional material is dependent on, e.g., pattern dimensions on the stamp, applied pressure when transferring the pattern to substrate. In addition, soft and elastic stamps are usually preferred with μCP as they conform better to the shape of the substrate resulting in more uniform deposition. The stamps are commonly made of poly(dimethylsiloxane) (PDMS) that can be patterned by, e.g., over-molding a photolithography-patterned silicon wafer, or by laser ablation. The first method allows extremely fine details for the PDMS-stamp. However, controlling the printing quality with the method is generally more difficult, e.g., as the adhesion between the elastomeric stamp, functional material, and the substrate needs to be considered and properly tuned to successfully transfer the functional material. Also, during transferring the functional material onto substrate, the deformation substrate and applied pressure may need additional considerations if the used substrate has low Young's modulus (less than 1 MPa), and the substrate is also very thin (only several hundreds of micrometers or less than that).

Gravure and flexography printing are high-volume throughput printing processes used by the industry for printed electronics manufacturing. While they share similarities in the roll-to-roll operation, in gravure printing the patterns are simply engraved to a cylinder that is partially submerged in the functional ink. After removal of the excessive material, the ink is left to the engraved recesses and can be transferred onto the substrate. In comparison, flexography printing uses flexible relief plates mounted on rotating cylinders. The ink is applied to the recesses on the plates when they are raised, which then transfers the ink to the substrate. Typical minimum resolution with these contact printing methods is close to the 10 μm with the viscosity of the functional inks being in the range of 5·10⁰-5·10² Pa·s. Similarly to stencil printing, the resolution in flexography printing is known to be limited by Young's modulus of materials from which the rolls are fabricated. This is because the fine features can be compressed during printing of the functional material leading to reduced pattern fidelity. In contact printing techniques, the capillary number (Ca) is important, and how it influences the flow and spearing of the ink. The Ca is dimensional quantity used in fluids dynamics to describe the relative effect of viscous forces to the surface tension forces (Ca=μV/γ, where μ is dynamic viscosity and V is characteristics velocity (e.g., printing speed)). For example, if the Ca is too large it can result in viscous forces dominating the flow of the ink leading to dripping and spreading beyond the desired boundaries. If Ca is too small, the surface tension dominates resulting in both poor wetting and spreading. Thus, the printing process for autonomously self-healing elastomers, composites and blends thereof can be optimized through by balancing the viscous and surface tension forces by Ca and understanding the process parameters (which are especially important in gravure and flexography printing due to their more complex operating principles).

In inkjet printing, the functional elastomeric inks are deposited by small nozzle that ejects droplets to the substrate, e.g. by using piezoelectric crystal. In the method, the droplet volume partly determines the thickness and resolution of the printed layer. While viscosity of the fluid affects the droplet formation, spreading and dying behavior. Thus, optimizing viscosity of the elastomeric ink is important and enabling proper wetting with low contact angle. In many cases the printing resolution of functional materials used for electronics manufacturing is around 360-720 dots per inch (dpi). The viscosities used in the method are generally lower than in other methods, e.g., in the range of 10⁻³-10⁻¹ Pa·s, or 10⁰-10² cP. This level of viscosity requires rheological modifications to the used autonomously self-healing polymers, polymer composites and blends.

The viscosities disclosed herein may be determined by using a rheometer or a rotational viscometer, by using the measurement standards ISO 3219:1993 and/or ASTM D2196-20. Also, the following standards may be used: ASTM D445-24: Standard test method for kinematic viscosity of transparent and opaque liquids (and calculation of dynamic viscosity); ASTM D1824-16: Standard test method for apparent viscosity of plastisols and organosols at low shear rates; and/or ASTM D2196-20. Standard Test Methods for Rheological Properties of Non-Newtonian Materials by Rotational Viscometer.

### Thin Film Deposition Methods

Thin film manufacturing enables versatile, scalable, and cost-effective deposition of functional materials onto various substrates. The methods involve deposition of thin films from solution-based precursors. The film can be deposited with tape casting, blade coating, bar coating, slot-die coating, spin coating and/or dip coating.

Tape or blade casting is a high-throughput method for fabrication of uniform thin films. The viscous solution (often called slurry) is spread across the surface with a casting blade to form uniform layer with controlled thickness. The gap between the casting blade and substrate defines the thickness of the layer before drying. Also, the viscosity of the solution, and coating speed play a role in determining the thickness of the layer. During drying, the thickness of the film further reduces due to evaporation of the solvent(s). The coating thickness (h) with blade coating before drying can be calculated as: h=Q/vw, where Q is volumetric flow rate of coating material (m³ min⁻¹), v is the coating speed (m s⁻²), and w is the width (m) of the coating blade. To know the coating thickness after drying, the solid content in the solution is necessary to know. The thickness of the dried film is then approximated by h_{d}=h_{w}·(solid content (%)/100%), where ha and h, are the thicknesses of the dried and wet film, respectively. The experimental measurements follow closely these equations.

Bar coating is similar to tape or blade casting, but instead of the casting blade, a cylinder bar with spiral wires is used for spreading the solution to the surface. The film thickness is mainly dependent on the gaps between the wires and substrate that control how much solution passes through to the surface of the substrate. In addition, applied pressure to the bar, coating speed, and viscosity of the solution influences the film thickness. More complex cylinder rod bars can be used for controlling the properties of the films without any compositional or chemical modifications of the material by simply controlling the orientation of functional fillers during printing. Generally, the minimum thickness of the film achievable with tape or blade casting, and bar coating is about ten micrometers.

Slot-die coating is roll-to-roll compatible thin film fabrication method that uses a narrow slot die head which is positioned close to the surface to deposit the functional material as the substrate moves. The solution flow rate from the reservoir to the slot die head is controlled precisely, e.g., with peristaltic (e.g., syringe pump) or rotary displacements (rotating elements transfer the solution). The slot die head is the most important design consideration in the system as it controls the distribution of the solution. The slot die head comprises parts such as inlet, manifold, shim, slot, and land which all can be adjusted to further control the meniscus. The method is generally considered more complicated than tape/blade casting or bar coating. For example, Poiseuille flow equation is generally used to describe the laminar flow of the Newtonian liquid as it passes through the narrow gap in the slot die head:

$$Q = ( Δ P π {r}^{4} ) / ( 8 η L ) ,$$

where Q is the volumetric flow rate of fluid, ΔP is pressure drop across slot die, r is the radius of the slot die, η is the viscosity of the fluid and L is the length of the slot die. This equation is relevant in the process as it helps to determine the flow rate and pressure needed to achieve uniform and precise coating at desired thickness. The advantages of the method are in thickness of the films achieved (up to nanometer range) and the uniformity of the films as they are considerable better if the process is controlled in adequate manner, while two-dimensional patterning is also possible due to movement of the substrate.

Spin coating is well-adopted laboratory-scale method for research and development purposes for fabrication of thin films by spearing a solution across a surface when the substrate is rotated at high speeds (typically above 1000 rounds per minute (rpm)). The diameter of the substrate is generally limited in comparison to other methods. Another drawback of the method is that the solution waste is high (>90%) as most of the material outflows during the spinning. At the start, the fluid spins at different speeds to substrate but will eventually match the as drag balances rotational accelerations. When fluid level becomes level, the solution begins to thin due to the viscous forces. The evaporation of solvent dominates the thinning after the fluid outflow stops. There are various of method to approximate the film thickness (h); the simplest is given by h∝1/√w, where w is the spin speed. However, the equation is generally not very accurate in practice as the solution deposition thickness depends on various factors, e.g., concentration, solvent evaporation rate, etc. The method is generally difficult to apply for the autonomously self-healing elastomers as they are non-Newtonian materials (i.e., their viscosity increases significantly with the shear rate). The non-Newtonian behavior and viscous solutions can lead to complex flow patterns, variations of the coating thickness across the surface, and poor quality in the final films. Optimizing the composition and spin coating parameters can be difficult if at the same time control of the viscosity of the solution is limited due to specific composition requirements. The spin coating is generally more applicable to elastomers that do not contain water as part of the solution.

In dip coating, the substrate is immersed in the elastomeric coating solution, and the solution wets the substrate during the immersion. The method can achieve extremely uniform films with thickness in nanometers. The minimum film thickness can be approximated through Landau-Levich equation as:

$${h}_{min} = ( η UL ) / ( pg ( cos ( θ ) ) ) ,$$

where η is the viscosity of the solution, U is the withdrawal speed, L is the width of the coating, p is the density of the fluid, g is gravitational acceleration, and θ is the constant angle between the fluid and substrate. Thus, the coating thickness is influenced by the viscosity of the solution, withdrawal speed, width of the coating, density of the fluid, and contact angle. The film quality and uniformity are dependent on, e.g., consistency in the withdrawal speed and good wetting. Similarly to spin-coating method, the solution waste in the method is high in comparison to other film coating methods, and the substrate size is also limited.

### Curing

After forming the shape, such as by additive manufacturing, casting, printing or other film deposition or application, the elastomers, such as ECLME, will be cured and cross-linked, such as at elevated temperature. The temperature depends on the self-healing elastomer matrix composition. For example, for EC7, the processing temperature is set to 70° C. Lower processing temperatures are also possible (e.g., even at room temperature), but this might influence the final properties of the liquid metal elastomers. In the case that the printing or film deposition system also contains a heating plate, the additional curing step may be unnecessary. In that case, the temperature on the heating plate is set to the required temperature of the elastomer composition/used elastomer composition in the ink.

In general, a layer may be tape cased on a carrier substrate, which can be used to transfer one or more layers to a target, such as onto another layer. Electrically conductive layers may be tape casted onto an existing layer, especially if is it desired to cover the whole surface of the substrate. However conductive layers may be also directly printed into a desired shape/form/pattern onto a substrate, for example with a stencil and/or silk screening, such as onto an elastomeric substrate or substrates.

Another option is to prepare the self-healing elastomeric films separately onto a suitable carrier substrate and form desired patterns before transferring onto a substrate and/or onto desired film layers. With this method however it may not be possible to obtain as good adhesion as in a method, wherein the layers are printed and cross-linked layer by layer on top of each other.

In respect of printing almost any printing method works as long as the masks or the like aids do not stick to the self-healing materials during printing. When printing conductive patterns with a mask, several features may be considered. The material of the mask shall be such that does not stick to the self-healing materials, as the mask is always in a physical contact with the elastomer. One suitable material is polypropylene carbonate (PPC) film, which may have a thickness of about 100 μm. It is also important that the mask is rigid enough, such as having a large enough thickness and/or the Young's modulus of the material is high enough, as the mask shall be first patterned into a desired form, for example, by laser. Thin, very flexible and/or clastic materials do not work if the formed patterns are small, such as having dimensions of 100 μm or less, due to deformation induced by the printing. It is also important that the mask is not deforming during printing, as otherwise the printing quality is poor. The mask may be prepared also with a material that adheres or sticks to the elastomer, but in such case the surface of the mask must be covered with a non-sticking layer. In other words, the self-healing materials shall have a higher adhesion between the layers than to the surface of the mask.

### Laser Processing

The self-healing liquid metal elastomer composite film or layer may be activated to enhance electrical conductivity. The activation may include sintering and/or other suitable laser treatment, wherein the surface of the liquid metal elastomer composite may be processed by laser, which may comprise activation and/or forming patterns. The activation results to enhancement of electrical conductivity.

In one embodiment the activating comprises laser-sintering and/or laser processing to remove oxide layer from the layer comprising a self-healing electrically conducting liquid metal elastomer composite to improve electrical conductivity thereof.

In one embodiment the surface of the layer comprising self-healing electrically conducting liquid metal elastomer composite is a laser sintered and/or an electrical conductivity-improved layer, such as a layer with laser-improved electrical conductivity.

In one embodiment one or more layers of the film is/are laser-patterned. The method may comprise treating one or more of the layers with a laser to form one or more patterns to the layer(s).

In one example the method, such as an activating method, comprises
forming the self-healing, electrically conducting liquid metal elastomer composite into a continuous layer, which may be a film, such as by tape casting,
at least partly curing the layer, such as by heating and/or crosslinking the layer/film,
treating the heated and/or crosslinked layer/film with laser to evaporate and/or sublimate solid elastomeric material from predetermined areas to form pattern(s) and/or to remove oxide layer to enhance electrical conductivity.

During laser processing, the polymer phases are vaporized from the surface with some of the LMMPs (due to Gaussian beam). As the excitation rate by laser is not large enough to cause photochemical reactions in the LM, a photothermal process occurs where the absorbed energy from the laser beam is instantly transformed into heat. Heating of the LMMP cores leads to inhomogeneous thermal expansion coalescing LMMP cores as the metal oxide shell is ruptured during the laser ablation. Densification also occurs due to thermal diffusion causing temperature in the ECLME film(s) to increase. The LMMPs underneath the coalesced regions show coarsening and fusing effects which leads to further increase in the electrical conductivity (total increase of 10⁵-10⁷ orders of the magnitude). The colour of the ECLME films typically transforms from light to dark grey after the laser sintering. The effect of laser-induced temperature increase to the growth of oxide layer can be neglected, e.g., due to coalescing of LMMPs that results in continuous electrical pathways in the ECLME films. The surface roughness of the polymer substrate films (to which the LM is deposited to) largely influences the outcome of the laser sintering. For example, too small MPs (d₅₀<1 μm; d₅₀=mean particle size) can create discontinuous electrical pathways in the ECLME films on a substrate that has high surface roughness, thus poor electrical conductivity in the laser sintered ECLME films.

In the case of laser-sintering, the photothermal process (i.e., absorbed energy is instantly transformed into heat) results in a localized heating in the polymer film. Due to provided thermal energy, the molecular chains have more kinetic energy (i.e., absorbed photons interact with the atoms/molecules in the polymer leading to excited electrons) increasing the flexibility and mobility of the polymer chains, thus resulting in breakage of dynamic reversible bonds and intrinsic flow in the polymer network, if melting and decomposition can be avoided. Therefore, a higher temperature generally promotes faster self-healing rate and makes the patterning more difficult with the laser ablation for self-healing materials where the chemical bonds are sensitive to temperature changes. Because the autonomous self-healing polymers in a form of films are often thick, highly viscous, and the flexibility and mobility of polymers is increasing with the temperature, it can be cumbersome to permanently pattern such materials with fine features, and good pattern fidelity. Moreover, a lack of long-term structural stability and poor creep resistance of the self-healing polymers can pose issues in maintaining the fine features over time if made of single polymer network due to gradual movement of the polymer chains resulting in creep. Also, generally, thicker autonomous self-healing polymer films are more difficult to completely cut through as the ratio of the depth of the cut to the thickness of the film is small. Therefore, the polymer film has time to self-heal at the cut regions before fully cut through (especially in the case also where the beam moves randomly around the patterning region/areas). Because the laser beam width is relatively small (tens of micrometers or less), and it only partially cuts the polymer network, the highly mobile polymer chains are wetting easily at the bottom of the damaged surfaces also as there is no misalignment at the cut-surfaces. This mechanism significantly reduces the effectiveness of the laser processing depending on the polymer material system, laser processing method and laser processing parameters.

Using laser ablation for the autonomously self-healing elastomers with high optical transparency may either require modifying the optical properties with small amount fillers, and/or needs a laser system that operates at UV range. The excellent patternability with the proposed materials with the laser ablation enables fabrication of complex two- and three-dimensional functional elastomeric structures with fine features, and high patterning fidelity limited only by width of the laser beam. The individual patterned film layers can be self-bonded together via self-healing enabling seamless integration of different functional materials together and building soft material-integrated electronics with the ultimate compatibility, as all materials are also based on the same base polymer/polymer system. After self-bonding the layers together, the layers cannot be separated without breaking the structure completely, making the soft polymer electronics devices ultraresilient, robust and reliable.

The key for achieving the patternability with the autonomously self-healing elastomers is based on the unique chemical and physical properties of base material, e.g., (i) having a fixed and permanent shape after cross-linking (due to the double network structure with combination of soft and hard chain segments), (ii) high resilience, (iii) good thermal stability, and (iv) reversible dynamic bonds that respond to the increase of temperature by reducing the flexibility and mobility of polymer chains.

It can be noted that (i) these double-network elastomers can achieve a fixed shape after complete cross-linking which means they are also capable of maintaining their original three-dimensional shape in long-term even after repeatedly deformed or broken apart. The long-term dimensional stability is also important for maintaining shape of the elastomer after being patterned two- or three-dimensionally with fine features.

(ii-iii) The strong entropic elasticity resulting in high resilience is associated with the microphase-separated interfacial regions capable of providing stable junction points in the double-network even under large stress. The high resilience is important for maintaining the desired patterns when the patterned film, for example, transferred to other functional layers in the process of fabricating film-based material-integrated soft electronics with the ultimate compatibility. The elastomers show high thermal stability up to temperatures about 300-500° C., or exceeding, which is particularly important for the laser processing. The high thermal stability reduces the possibility of thermal damage during laser ablation and allows more process control in terms of the used lasering parameters, and layer transfer/bonding.

(iv) The dynamic reversible bonds in the soft phase are known to be highly sensitive to presence of water molecules due to reversible hydrolysis/condensation which increases the supramolecular interactions of Si:O—B bonds as additional free groups may appear. During heating the chemical and network structure of the elastomer changes due to the dehydration resulting in condensation of boranol groups into boroxane linkages that reduces the flexibility and mobility of the polymer chains in the soft phase. The boranol groups (—B(OH)₂) at the polymer chain ends undergo a condensation reaction within the elastomer network leading to formation of boraxane (—B—O—B—) linkages. In other words, the removal of water from the boranol groups leads to formation of these linkages which results in more interconnected and cross-linked rubbery-like boroxane elastomer that further promotes the elasticity of the network. Thus, condensation of (—B(OH)₂) improves the laser ablation by also reducing the self-healing speed of the polymer during the photothermal process. The dehydration typically occurs near the low cross-linking temperature of the double-network elastomer. The dehydration of the elastomer network is also beneficial as the water vapor can absorb the laser energy which affects the distribution and intensity of the laser beam during the processing. Thus, dehydration can result in more effective laser ablation. Because the elastomer network is in hydrated state before the laser processing, it can be advantageous for few other reasons. The water vapor on the surface can reduce the scattering of laser beam by providing a homogenous medium with similar refractive index to the polymer, thus leading to better penetration of the laser beam. Moreover, the water vapor can act as thin thermal barrier layer preventing the localized overheating by distributing the heat more evenly and help in mitigating the thermal stress by cooling the surrounding area, thus reducing thermal gradients within the elastomer, and further reducing the risk of thermal damages.

### Film Requirements for Laser Processing (and Layer Transfer)

The self-healing elastomers, composites and/or blends are deposited to chosen substrates. The substrates can be either donor or acceptor films, that both are used for building material-integrated electronics layer-by-layer. The deposited, specific functional layers on the substrate, or within material structure, can also have either a single layer or comprise or consist of multiple layers made of the same material, or a similar material with adjusted composition. The individual layers can be made either a single material or multiple different materials (dielectric, conductive, and/or semiconductive) with specifically adjusted composition.

In the case that the films are continuous and made with the film deposition methods, the film(s) on the substrate can be two- and/or three-dimensionally patterned with the lasering.

In the case that the films are patterned with the additive manufacturing methods, the printing method defines the resolution limit for the patterning because the laser ablation resolution limit is lower than achievable with any of the printing methods. The three-dimensional patterning with the laser can be then used to further modify the surface of the patterned film(s) or used for laser sintering in the case that there is printed ECLME film layer.

The ECLME film layer can be either non-patterned, or pre-patterned with the printing method. In the case that the ECLME layer is not patterned, the laser sintering can be used to both pattern and sinter the film simultaneously. In the case that the ECLME film is prepatterned, the patterned regions can be laser sintered. A sintering may be considered as a pattern.

Generally, the thickness of the film to be patterned, such as autonomously self-healing polymer, elastomer film, composite and/or blend layers may be in the range of 1-1000 μm, preferably in the range 1-200 μm, and more preferably in the range of 5-100 μm or 20-100 μm. Film thickness in the range of 20-50 μm, such as 25-40 μm, was found preferable to produce high quality printed films. However, the layers can be thinner than 1 μm, if possible, with the film fabrication method, down to nanometers range, such as with slot-die coating. In such cases the thickness of the film may range from for example 100 nm, or from 500 nm, up to the micrometer ranges discussed herein, such 100 nm to 1000 μm, for example 500 nm to 1000 μm or 500 nm to 200 μm. Generally, thinner films are preferred for both two- and three-dimensional patterning to reduce the probability of thermal damage, and possible material residue on the surface of the patterned films. In the case that thick films are used, the cutting or engraving depth should be minimized. When using thick films, deep engraving or total removal of the films is not often advisable due to possible residue and debris that can be generated on the substrate/film which is then difficult to completely clean.

For ECLME films and other conductive layers comprising and/or made of autonomously self-healing polymers, elastomer films, composites or blends the thickness is most preferably in the range of 5-100 μm. Generally, the thickness of conductive film layers, or conductive parts in material-integrated soft electronics design should be closer to tens of micrometers to avoid unnecessary increase of resistance, if the feature size is also small, such as in the range of 10-100 μm or in the range of 20-80 μm. This is because the resistance is inversely proportional to the cross-sectional.

The color of the autonomously self-healing polymers, elastomer films, composites, and blends can be adjusted for the laser processing beforehand if needed in order to reduce laser beam scattering with materials having high optical transparency.

Disclosed is a method for patterning a self-healing film, and/or for laser sintering a self-healing liquid metal elastomer composite film and/or for improving/enhancing electrical conductivity of a self-healing liquid metal elastomer composite film. The method for improving/enhancing electrical conductivity of a self-healing liquid metal elastomer composite film may be a method for surface-treating the film. The method may comprise
providing a programmable laser processing system,
providing a predetermined design model in a program code format for forming one or more patterns, for forming one or more sintering(s) and/or for treating a surface of an object, to program the laser processing system with the design model to cause the laser processing system to form the one or more patterns, sintering(s) and/or surface treatment(s) to an object when operated,
providing, such as applying, a self-healing elastomer film on a substrate, such as a self-healing liquid metal elastomer composite film,
at least partly curing, such as heating and/or crosslinking, the self-healing elastomer film, before processing with the laser, to obtain at least partly cured film,
providing the at least partly cured self-healing elastomer film to the laser processing system as the object,
treating the at least partly cured film with the laser processing system to partly or completely remove, such as evaporate and/or sublimate, solid elastomeric material from predetermined areas with the laser to form patterns, such as pattern shape(s), sintering(s) and/or surface treatment(s) defined by the design model to the self-healing elastomer film, to laser sinter the self-healing elastomer film and/or to remove oxide layer from a surface of the film to improve electrical conductivity of the self-healing elastomer film. A laser-treated film is obtained. A surface treatment, such as the removal of an oxide layer, may comprise and/or be carried out as a pattern, which may cover a part of the film or the whole area of the film.

One example provides a method for laser sintering a self-healing liquid metal elastomer composite film and/or for improving/enhancing electrical conductivity of a self-healing liquid metal elastomer composite film, the method comprising
providing a programmable laser processing system,
providing a predetermined design model in a program code format for forming one or more patterns and/or treatments to program the laser processing system with the design model to cause the laser system to form the one or more patterns to an object when operated,
providing a self-healing liquid metal elastomer composite film on a substrate,
at least partly curing the self-healing liquid metal elastomer composite film, before processing with the laser, to obtain at least partly cured film,
providing the at least partly cured film to the laser processing system as the object,
treating the at least partly cured film with the laser processing system to partly or completely remove, such as evaporate and/or sublimate, solid elastomeric material from predetermined areas with the laser to remove oxide layer to improve electrical conductivity of the self-healing elastomer film. A laser-sintered and/or an electrical conductivity-improved/enhanced film is/are obtained. The terms improve and enhance may be used interchangeably.

The object refers to the object of the laser treatment, which may be the films discussed herein. The laser treatment may be any of the treatment disclosed herein, such as patterning, sintering, surface treatment, removal of oxide layer and/or improvement/enhancement of conductivity. It was found out that not only the presently disclosed liquid metal composite films benefit from the laser processing methods, but also other elastomeric films and/or composites and/or products may be applied as objects as well. The self-healing films discussed herein may comprise an elastomer, an elastomer composite, and/or elastomer blend, or combination thereof.

The self-healing elastomer film may be any suitable self-healing elastomer film, which can be patterned and/or sintered by laser. The self-healing elastomer film may be autonomously self-healing elastomer film. The self-healing elastomer film may be a composite film, i.e. a composite in the form of a film, or other suitable substantially planar or sheet-like structure, which can be patterned or otherwise treated with the present method.

The self-healing elastomer film may comprise an elastomeric matrix comprising a polyborosiloxane-based polymer and/or a polydimethylsiloxane-based polymer, such as disclosed herein. The self-healing elastomer film may comprise an elastomeric matrix comprising PEDOT:PSS based elastomer or a composite comprising thereof.

The self-healing elastomer film provided for laser treatment/patterning/sintering/treatment may be on a substrate. If necessary to increase the conductivity obtained by the laser processing or other properties required in the process, a non-conductive self-healing polymer/elastomer may be provided as intermediate layer between the substrate and the self-healing elastomer film. The intermediate layer may also be electrically conductive.

In the patterning a self-healing elastomer film is provided on a substrate, which may be a first substrate. It may be prepared onto the substrate as a layer of material, a coating and/or a film. The type and material of the substrate is selected according to the use and purpose of the substrate, and according to the target wherein the treated film is to be transferred and/or applied. The substrate may be a donor substrate or an acceptor substrate.

Preferably the substrate does not permanently adhere to the materials/films to facilitate treatment when treated films are cleaned afterwards, and/or released and transferred to another substrate or to a product from the substrate. This is especially desired in the case of a donor substrate.

Preferably the donor substrate does not comprise a self-healing elastomer, unless the self-healing properties are weakened, such as via modification of chemical composition, to avoid too strong adhesion of the laser-treated film to the surface of the donor substrate. The donor substrate may be or comprise glass, silicon wafer, metal film and/or polymers other than self-healing polymers, preferably hard polymers, such as polyimide and/or polyethylene terephthalate. The surface of the silicon wafer and glass (sheet) have very high surface smoothness, so it may be necessary to prepare the materials onto these substrates.

In one embodiment the acceptor substrate comprises a self-healing elastomer. The acceptor substrate may be a final substrate, such as a part, a substrate or an encapsulating layer of the final product.

The elastomer, composite and blend film/layer/coating shall be solid enough to be processable with the method. Therefore, a self-healing elastomer film is partly or fully cured before processing with the laser. Usually, it is preferred that the film is partly cured, and it may be fully cured at a later phase, such as after transferring to another material, such as to an acceptor substrate. The film may be cured by crosslinking and/or by heating. Self-healing materials, especially the materials and matrices discussed herein, may be usually partly cured by heating to about 70° C. for 10-60 minutes. The (partly) curing facilitates the lasering accuracy and efficiency.

The self-healing elastomer film provided for laser treatment may be non-patterned or it may be pre-patterned by printing, such as by a printing method disclosed herein. Two-dimensional patterning may be carried out with hatching, cutting, and/or drilling tool(s).

The thickness of the self-healing elastomer film provided for laser treatment is in the range of 0.1-1000 μm, such as in the range of 1-1000 μm, 1-500 μm, 1-200 μm or in the range of 5-100 μm, or any other range disclosed herein.

The method may comprise removing unnecessary portions from the laser-processed material. This can be done during the laser treatment and/or after the laser treatment, for example, by mechanically removing the unnecessary portions. Mechanical removal requires solid enough film, and that the cut-through of the material was successful. Preferably the film shall not be too thick.

The donor substrate may be a release substrate, or the film is releasable from the donor substrate, for releasing and transferring the processed film to another substrate and/or a final product. The donor substrate is selected according to the used material in the film, and according to the purpose of the laser-treated film. The film is to be released from the donor substrate, transferred and/or placed to a desired target, which may be another substrate, such as a second donor substrate, an acceptor substrate or another target, such as a product, preferably a final product to which the laser-treated film is intended to be included.

The method may comprise releasing the laser-treated film from the (donor) substrate and transferring the released laser-treated film to another substrate and/or to a product, which may be called a target substrate or a (target) product. A multilayer structure may be obtained or prepared, for example comprising two or more laser-treated films, or at least one laser-treated film, and one or more other films or other substrates.

The material of the laser-treated film shall be attached to the other substrate, or to the product, preferably with a higher adhesion than with the first substrate. Alternatively, the film may be released from the first substrate by using methods lowering the adhesion, such as by heating the layer, by swelling under water, or the like methods which do not damage the film.

If a functional electronic structure or device is made, the layers must be transferred individually in a certain order, either to another donor substrate (from which the entire structure is then finally transferred to the acceptor) or to the acceptor substrate. Also, complete transfer of multilayered structure from the first donor substrate to another donor or acceptor substrate is possible. In practice, e.g. a component structure can be made either in the correct order (bottom-to-top (BtT)) or upside down (top-to-bottom (TtB)). Similar applies to any multilayered structure used, for example, as stretchable interconnections. For TtB, the component structure can be made e.g. on top of an encapsulation layer, while in BtT on top of the substrate. The third option is to make the structure partly on e.g. the substrate and partly on top of an encapsulation layer, after which substrate and the encapsulation layer parts are combined. The principle is to avoid deformation of active areas of the device while assembling the structure. That is, the way of stacking is chosen according to the materials used and the structure/device of the component

If a functional structure is assembled layer by layer or made on e.g. a self-healing elastomer (acceptor substrate), then each transferred layer is first allowed to adhere for some time before the next layer is transferred and self-bonded. Self-bonding may be facilitated by heating the film structure after joining the layers before removing the donor substrate mechanically from the surface of the layer to be bonded.

A liquid metal elastomer layer can usually never be transferred from one substrate to another, thus it must be printed or applied on top of another material, which is either transferable to another substrate, or is the final substrate or structural part of the component or device.

Disclosed is a laser-patterned and/or laser-sintered, and/or (laser) electrical conductivity-improved/enhanced/surface-treated, self-healing film, such as a liquid metal film, or a multilayer film comprising thereof, obtained with the method for patterning self-healing films, with the method for laser sintering self-healing films and/or with the method for enhancing/improving electrical conductivity of a self-healing elastomer film. The preparation method can be detected from the final patterned and/or laser sintered and/or electrical conductivity-improved self-healing film by examining the product with common methods, such as by using microscopic methods to identify the laser processing made by programmable laser processing system and/or the structure of the product, such as seen from a cross-section. For example, it is not possible to obtain similar accurate patterning, depth of the treatment and/or other properties without using laser, which is computer-controlled, i.e. programmed. It is also possible to detect residue and/or debris left onto the films upon complete removal of the film from carrier substrate, for example in hatching. Also, other properties can be detected from the final product, such as conductivity, optical properties, self-healing properties, mechanical properties, electrical properties, deformation properties and the like. A liquid metal elastomer on a surface of other material can be characterized microscopically, such as using SEM to examine the surface of the material, and to characterize the material structure. The products can be disintegrated to monitor the behavior of the material/product. The detected properties can be compared with the properties of a reference product, which may be such as disclosed herein.

The laser-patterned, the laser-sintered and/or the (laser) electrical conductivity-improved self-healing electrically conducting liquid metal elastomer composite film in a multilayered film structure may have a conductivity of 800 S cm⁻¹ or more, such as 1000 S cm⁻¹ or more, or 2000 S cm⁻¹ or more, such as in the range of 800-14000 S cm⁻¹, for example in the range of 1000-10000 S cm⁻¹ or 2000-10000 S cm⁻¹.

Disclosed is a multilayered self-healing electrically conducting elastomer film and/or product or part thereof comprising one or more of the patterned, laser sintered, and/or electrical conductivity-improved/surface-treated multilayered self-healing electrically conducting liquid metal elastomer composite films.

Disclosed is use of a programmable laser processing system for patterning a self-healing elastomer film, which may be a part of a multilayer film, for laser sintering a self-healing elastomer film and/or for improving the electrical conductivity of a self-healing liquid metal elastomer composite film with the method.

### Laser Systems and Processing Parameters

A suitable programmable laser processing system may be used, which comprises one or more controllable laser devices, i.e. laser sources, and one or more programmable control unit(s), i.e. electronic controlling means, configured to operate the laser device(s) and/or the programmable laser processing system, according to a model and/or a program code. The laser device(s) may comprise and/or may be connected to one or more actuators, such as electrical motors, for directing the laser beam(s) provided by the source(s) of laser, such as by using controllable mirrors to direct one or more laser beams to an object, and preferably to move the laser beam(s) in orderly fashion to form patterns to the object. The actuator(s)/motor(s) is/are operatively connected to the programmable control unit. The programmable control unit is arranged to direct the laser beam to the object in a programmed manner. The system may comprise a platform or the like receiving part for receiving the object. The receiving part may be controllably movable by one or more actuators.

A predetermined model in the form of a (computer) program code may be loaded, programmed, formed, and/or specified in the system, i.e. the system may be programmed with the program code, and the system is arranged to control the operation of one or more laser devices/beams to process the target/object with the laser according to the model, such as to form one or more predetermined patterns specified in the model, and/or to use any specific methods for implementing the patterns, cutting and/or any other desired operation with the laser, such as by using hatching.

The program code comprises a predetermined design model of one or more patterns, which may be provided in a suitable/specified format, which is compatible with the laser processing system. The laser system is programmed with the design model, preferably by providing the model in a program code format, wherein the laser system operates to form the pattern(s) on a target. The model may comprise information to form one or more layers of patterns, which may be formed on different films, and the model may comprise instructions to treat each separate leys in an individual manner, such as with different laser settings, with different tools and/or with other parameters and/or ways to control the treatment.

The model is provided in an electronic form, such as a file and/or a program code provided to the control unit. The model contains instructions, such as a model or a template of patterns and/or hatches to be formed in the target, and/or to form laser sintering on the target, according to which the patterns, hatches and/or sintering is/are formed to the target by one or more laser beams. The patterning may be two dimensional and/or three dimensional.

A suitable file format is used, which is preferably compatible with common CAD software or the like, and with the laser processing system, and wherein the image/model can be edited and scaled without deterioration of the quality. One preferred file form is DXF, which is based on open source and provides two-dimensional vector graphics in standardized form. DXF also enable preparing several layers, which can be programmed to be implemented in different ways with the laser system software. These features are preferred by the software settings. Other suitable file format include SVG (scalable vector graphics, .svg, .svgz), EPS (.eps, .epsf, .cpsi), STL (stereolithography, .stl), and Gerber file (.gbr)

The control unit comprises one or more processors and a memory, which is arranged to be programmed with the model or the like instructions for operating the system to process the target material with the laser according to the programming. The electronic controlling means, including the program code, the memory and the computer program code is configured, with at least one processor, to control the operation of the laser processing system. More specifically, the model may be or provided as a computer program product or a computer program code embodied on a non-transitory computer readable medium, comprising computer program code configured to, when executed on at least one processor of the programmable laser processing system or the control unit, cause the laser processing system to perform the method or part thereof.

A data storage medium may be provided to comprise the program code comprising and/or providing the model. The program code may be prepared separately, such as at a remote location and/or device, or the system may be programmed with a computer or other terminal connected to the system. The program code, i.e. a computer program code or program instructions, may be embodied in a network location, in a computer, in a physical data storage medium or in any other suitable source, which may be local or remote, and/or may be installed to the programmable laser system or to the control unit from such source. The expressions “data storage medium”, “computer-readable medium” and the like medium include the sources. The program code is preferably run in a processor of the system and/or the control unit and may be embodied in a memory, such as a non-transitory computer readable memory or medium, of the system and/or the control unit or in an external or remote medium.

The laser processing system may be programmed to form laser sintering, three-dimensional patterning and/or surface treatment on the target/object.

A hatching tool can be used for laser sintering and/or for three-dimensional patterning. The laser processing system may be programmed to form hatch patterns on the target/object, such as the self-healing elastomer film, with a hatching tool, and/or to provide a hatching tool and/or a hatching function, wherein the hatching tool/function is configured to move the laser beam as one line at the time in an orderly fashion to form of a hatched pattern with a plurality of the lines as the predetermined pattern to remove material from the target/object/film on the hatched pattern.

The programmable laser processing system is arranged to receive and/or process a target, such as an object and/or a target object, which can be applied to the system, such as to a receiving portion of the system, which may comprise a planar surface to which a target is to be applied, and which can be processed with the laser device/source of the system. The target may be planar, such as the film or any other applicable product disclosed herein. The laser processing system uses suitable laser wavelength, which may be adjustable, and may be selected according to the properties and/or material(s) of the target/object. Preferably the wavelength is 400 nm or less, such as in the range of 100-400 nm, to avoid thermal damage in materials, and to enable treatment of optically transparent, translucent, and/or reflecting materials. Other properties of the system may be also controllable by the control unit.

One example of a suitable laser processing system is LPKF Protolaser U3, achieving a minimum cutting width of 18 μm with the laser beam width of 15 μm, i.e., maximum theoretical resolution limit is about 1400 DPI. The maximum size for the film that can be fitted into the system is 305 mm×229 mm, while the working area that can be processed at once is limited to approx. 49.9 mm×49.9 mm (or 2490.01 m²). When the pattern is larger than 49.9 mm×49.9 mm, the pattern will be automatically divided into multiple sections of similar size which can be controlled to some degree in the software. Each square will be processed one by one by the laser beam.

The laser processing parameters (frequency, power, jump delay, etc.) and their possible ranges are adjustable. The maximum power in the LPKF Protolaser U3 is frequency limited. Other parameters are also limited simultaneously, e.g., maximum mark speed is 500 mm s⁻¹ at 50 kHz frequency.

The laser processing system, such as the LPKF Protolaser U3, may work at wavelength of 355 nm which is generally well-suited for wide range of materials including variety of polymers. This is because the optical transparency of polymers and other materials quickly decreases below 380 nm due to absorbed ultraviolet radiation to the atomic and molecular structure. Particularly, in high molecular weight polymers, the more densely packed polymer chains can increase the UV absorption through interactions between the neighboring polymer chains and/or within the polymer backbone which can improve the cutting of materials. The 355 nm wavelength is also particularly good for reducing the possibility of thermal damage, and for achieving a higher spatial resolution with sharper edges.

Generally, any profile that can be used for partially cutting optically transparent or translucent, soft polymers (Young's modulus ≤10⁰ GPa) at visible wavelength (380-700 nm) works well for finding the starting profile settings for fine tuning of laser processing parameters for the autonomously self-healing polymers, composites, and blends made of same base material (having poly(dimethylsiloxane)-backbone)). The fine tuning of the profile is typically done mainly by controlling frequency, power, mark speed and number of repetitions. A good example of a commercial film in which laser processing parameters can be used as the starting point is Covestro Platilon® 4201 AU polyurethane (ether) film.

For patterning and/or laser sintering the autonomously self-healing elastomers, jump delay and speed, laser off- and on delay, and tool delay are less important parameters in comparison to frequency, power, mark speed and number of repetitions. However, in fine tuning the lasering profile for a certain material, all parameters may require to be adjusted one by one, and the quality in the films needs to be inspected after the laser processing with the optical microscope, or the like methods. Any sign of thermal damage or microstructural change is indication that the parameters need to be fixed, or if the cutting edges are not sharp.

Typically, the jump delay and jump speed are fixed to 1,000-1,100 μs and 1,000-1,100 mm s⁻¹, respectively. The laser off- and on delay to 200-400 μs and 0-100 μs, respectively, and tool delay to 0-100 ms.

Typically, frequency range of 25 kHz to 100 kHz is used for patterning and/or laser sintering. The maximum power with the laser system is then limited to ≤5.3@25 kHz, ≤5.8 W @ 30 kHz, ≤5.9 W @ 35 kHz, ≤6 W @ 40 kHz, ≤5.7 W @ 50 kHz, ≤5.2 W @ 60 kHz, ≤4.655 W @ 70 kHz, ≤4.1 W @ 80 kHz, ≤3.65 W @ 90 kHz, and ≤3.2 W @ 100 kHz. The autonomously self-healing polymers, composites, and blends are laser patterned and//or laser sintered typically at the frequency of 25-100 kHz, preferably 30-80 kHz, and more preferably 35-75 kHz.

Although, the mark speed is also frequency dependent, the mark speed is typically set in the range 0-500 mm s⁻¹. As a rule of thumb, lower mark speed is preferred for the two-dimensional patterning, while higher mark speed is preferred for the three-dimensional patterning or laser sintering.

A typical starting profile parameters for two-dimensional patterning may comprise:
Frequency 40 kHz
Power 6.0 W
Jump delay 1,000 μs and jump speed 1,000 mm s⁻¹
Laser off delay 350 μs and laser on delay 50 μs
Mark delay 400 μs s⁻¹ and mark speed 200 mm s⁻¹
Repetitions 5, tool delay 50 ms

The frequency, power, mark delay, and repetitions are usually the first parameters to be adjusted depending on the material and its composition. Generally, the number of repetitions needs be increased when the thickness of the autonomously self-healing elastomer films increases to fully cut through the film. Generally, autonomously self-healing elastomer compositions with longer self-healing recovery times (>1 hour for partial or full recovery of tensile properties) may require less repetitions when the film thicknesses increase over 200 μm as the films are cut through more easily. If the self-healing rate is extremely fast (within minutes or less for partial or full recovery of tensile properties), it can be impossible to cut through thick films. The cuts made with the laser beam are likely self-healing faster than depth of the cut is increasing due to large number of repetitions needed to cut through the film in the first place, and random movement of the laser beam around the pattern. Thus, one location is not cut properly before moving to other part. Because the cut-surfaces are fully in physical contact, self-healing is extremely efficient with autonomously self-healing elastomers that are highly viscous.

Typical profile parameters for laser sintering of ECLME may comprise:
Frequency 50 kHz
Power 2.3 W.
Jump delay 1100 μs and jump speed 1000 mm s⁻¹
Laser off delay 350 μs and laser on delay 50 μs
Mark delay 400 μs s⁻¹ and mark speed 400 mm s⁻¹
Repetition 1, tool delay 50 ms

The power should be adjusted depending on the composition of the eutectic mixture. For example, a liquid metal with lower melting point added to the elastomer requires application of lower power to be applied for the laser sintering. For example, for eGa_{75.5}In_{24.5} the power is first set to about 2.3 W, and for eGa₆₉In₂₂Sn₉ the power is first set to about 2.1 W, before further adjustments are made. Typically, the laser sintering requires power in the range of 1.6-2.5 W with Ga-based metal alloys mixed with the self-healing elastomer matrix.

Electrical Conductivity of ECLMEs (without Strain)

As confirmed experimentally, the electrical properties of multilayer film in respect of the liquid metal elastomers are mainly influenced:
By the metal alloy composition forming the LMMP, and the amount of liquid metal in the relation to the total amount of elastomer components.
   The choice of self-healing elastomer and its composition does not affect the electric properties of liquid metal elastomer.
   Generally, a small amount of carbon nanotubes, such as less than 1.0% by weight, does not significantly affect the electrical conductivity assuming also that the volume loading of liquid metal is above the percolation threshold (55 vol. %)
   Addition of hydroxypropyl cellulose improves the electrical conductivity due to LMMP segregation (above the percolation threshold for LMMP).
The effect of the film thickness to the electrical conductivity is negligible. For example, 20-100 μm thickness is sufficient to produce high quality printed films. Thinner layers are not usually possible with the common printing methods without affecting the quality of the films or coatings.
Printing and/or laser sintering direction influences the final electrical conductivity; either by improving or decreasing it.
   Depending also on the substrate on which the liquid metal elastomer is made on, e.g., on substrate with poorer wettability, printing along the smallest dimension of pattern (in a case of simplistic line) is not often possible.
Printing method
   Generally, LMMP tends to orientate along the printing direction regardless of the method; however, certain methods can be more effective in aligning the LMMP during printing, e.g., using bar coating instead of screen printing.
Choice of substrate plays a major role in the non-strained electrical conductivity achieved directly after the deposition and laser sintering:
   On some substrates, the liquid metal elastomer is not electrically conductivity even after the laser sintering, e.g., Reynolds Ecoflex® 00-20 silicone rubber.
   The electrical conductivity improves by factor of 1.6-1.8 on self-healing elastomers, if compared to conventional non-healable elastomers, e.g., EC7 (780-1620 S cm⁻¹) vs. Reynolds Dragon Skin® 10 medium silicone rubber compound (470-880 S cm⁻¹)
   Printing on intermediate layer (on top of the substrate) made of self-healing polymer/elastomer generally improves the electrical conductivity and achieving a conductive layer even on Reynolds Ecoflex® 00-20 silicone rubber is possible.

The above do not take into consideration the effects of other layers, which also may have impacts to the conductivity. For example, the first layer between the substrate and the ECLME layer exhibit properties which may have impact to the conductivity. Also, the structure as a whole may have an impact, such as whether or not the first layer completely overlaps with the liquid metal elastomer layer. In stretching the conductivity is affected by the different layers, for example one layer may have lower stretchability but has a higher conductivity, and another layer has opposite properties. Also the contact and/or adhesion between the layers have impacts.

### Application of the Elastomer Composites and Devices Comprising Thereof

The present multilayer films exhibit properties that were found advantageous, for example for the applications disclosed herein.

The liquid metal elastomer composites offer several advantages and benefits that are difficult to achieve with many other types of materials, such as:
High electrical conductivity at moderate filler volumes
up to about 9,500 S cm⁻¹, that further increases with tensile strain (close to pure eGaIn when strained)
Strain-insensitive electrical resistance (i.e., R/R₀ close to 1.0 up to about 600% tensile strain)
Ideally, the resistance does not change under tensile strain; however, the requirement for this is that the electrical conductivity increases with stretching. This is often not possible with soft matter as the physical distance between filler particles increases with the tensile strain.
Excellent elastic deformability for both stretching and compression
Good adhesion properties to wide range of materials
Electrical and mechanical self-healing, where the tensile properties, and electrical conductivity with and without tensile strain recover after mechanical damage
Excellent leakage resistance under deformation
Excellent patternability at high resolution
Excellent film forming ability, and compatible with meniscus-guided deposition methods
Intrinsic softness due to low Young's modulus (in MPa range, or less)
Notch-insensitivity (when combined with self-healing intermediate layer)
Can be deposited to any type of substrate and sintered effectively (when combined with self-healing intermediate layer)
Possibility to use as piezoresistive sensing material in sensor applications (the strain sensitivity/insensitive can be adjusted with composition)
Good mechanical, electrical and thermal stability, and moisture insensitivity
Excellent cyclic stability of electrical properties under large deformations

The ECLME may be based on the bimodal self-healing poly(dimethylsiloxane)-based supramolecular elastomer. Thus, they share many of exceptional properties of the elastomers, such as high levels of elastic deformability, excellent universal adhesion, and (autonomous) self-healing. While the high electrical conductivity, and stable resistance under large tensile strain make them also feasible for wide range of methods and related applications listed herein.

The “soft” as used herein refers to properties of the material, which may be considered soft, such as including flexibility, elasticity and the like properties. Softness and hardness can be used as measures of the resistance to be localized plastic deformation. Hardness and softness may be dependent on the rheological and mechanical properties of materials, including but not limited to Young's modulus, flexibility, elasticity, tensile plasticity, strain, strength, toughness, viscoelasticity, and/or viscosity. Hardness, or hard matter, can be contrasted with softness, or soft matter. The “soft” may also have the general meaning of defining a type or groups of materials or products, such as in “soft electronics”. The term “soft” in contexts such as soft electronics, soft components, soft robots, soft sensors, and the like soft devices, distinguishes from conventional devices implemented with conventional, “hard” materials, such as conventional non-soft electronic devices, components, substrates, supports and/or the like.

The present liquid metal elastomeric composites and/or films and other structures comprising thereof can be used in a variety of applications, such as units, appliances and/or other devices or parts thereof discussed in the following. In general, the expression “device” is used herein to refer to physical applications implementing the present elastomeric composites. Two or more of the applications, appliances, devices, materials or features thereof can be combined where applicable. The applications, appliances, materials and/or devices disclosed herein can be connected to further devices and applications, such as to a controlling means, for example one or more control units electronically connected to the devices, films, applications etc. disclosed herein and/or other suitable units or appliances comprising the elastomeric composites. The controlling means are arranged to receive information from the connected devices, and/or the controlling means are arranged to carry out controlling actions to adjust the operation of the devices, where applicable. The controlling means may be electronically connected to the devices, and/or they can be chemically, electronically and/or mechanically connected at a material interface. Many applications utilize, are, or comprise electronic devices, and/or are connected to electronic devices. The applications may utilize soft materials and/or devices as a part of the system, that are then combined with (conventional) hard materials and/or devices. Such applications can achieve improved functionality and/or performance.

A controlling means can interact with and/or provide human-machine interfaces (HMI), which can create more intuitive and interactive interfaces for controlling devices comprising the present materials or other devices disclosed herein. For example, an interactive human-machine interface (iHMI) enables humans to control and/or interact with hardware and/or system, and to collect feedback information. Prior art iHMI systems based on rigid electronics have constraints in terms of wearability, comfortability, breathability, long-term (bio) compatibility to soft tissues, signal-to-noise ratio (SNR), and aesthetics. The present materials enable overcoming such drawbacks and providing completely new types of interfaces, devices, and applications.

To prepare electrical devices or parts or structures thereof, the present multilayer films may be combined with one or more electrical components. In this way it is possible to obtain electrical devices or parts of the devices which exhibit elastomeric and/or self-healing properties discussed herein.

In one embodiment the method comprises combining the multilayer self-healing electrically conducting elastomer film with one or more electrical components to prepare an electronic device.

The present application provides a method for preparing an electronic device, or part thereof, the method comprising
providing one or more of the multilayer self-healing electrically conducting elastomer films,
providing one or more electrical components, and
combining the one or more multilayer self-healing electrically conducting elastomer films with the one or more electrical components to obtain an electronic device, or a part thereof, comprising the multilayer self-healing electrically conducting elastomer film(s). The electrical component may refer to any component or other parts, such as disclosed herein, which can be combined with the multilayer film to obtain an electronic device or part thereof. The “part thereof” refers to any part or intermediate construction that can be used in a final electronic device or forms a part thereof. The electrical component, or a conductive part thereof, is connected to one or more electrically conductive layers of the multilayer self-healing electrically conducting elastomer film.

The present application provides use of the multilayer self-healing electrically conducting elastomer film for preparing an electronic device.

The present application discloses an electronic device comprising the multilayer self-healing electrically conducting elastomer film.

One embodiment provides an electronic device, or a part thereof, comprising the multilayer self-healing electrically conducting elastomer film and/or other structures comprising thereof, such as disclosed herein. Structures can be also obtained by additive manufacturing.

The present multilayer structures/films can be prepared by one operator, and they can be further processed by a second, a third and/or further operators. For example, the surface of the multilayer structures/film may be treated and/or patterned by the first operator, and/or one or more of such operations, processing and/or fabrication steps may be carried out by another operator. Further, the same and/or further operator may use the multilayer structures/films for preparing devices or parts thereof, and the devices may be further processed, used, and/or finished by the same or by a still further operator. The present multilayer structures/films can be packed, stored, transported and/or otherwise handled by the operators, and the products and materials can tolerate such handling. The final multilayer films may be, for example, wound into a roll (with appropriate carrier substrate) for transport and storage.

In embodiments the electronic device is, or comprises, one or more of an antenna, a sensor or a bioelectrode, a measurement circuitry, a piezoresistive sensing layer, an electrode, such as a bioelectrode, and/or a terminal of electronics component, a heating element, an electromagnetic device, a soft robot, printable electronics, stretchable electronics, soft electronics, self-healing electronics, electronic skin, implantable electronics and/or wearable electronics comprising the self-healing electrically conducting elastomer composite film(s). Preferably the mentioned device parts are made of, or comprise, the present elastomer composite(s). Also, other applications, devices, components, parts thereof and or the like can be provided, such as discussed

One example provides the present multilayer self-healing electrically conducting elastomer film for thermal cooling and heating, e.g., in wearable resistive heaters. For example, a planar printed conductor structure may be provided on the surface of another material or substrate as a resistive heating element. Electric current is conducted through the resistive structure and the loss of electrical energy causes heating of the resistive element and its surroundings. In an example, such heating element or heater comprises an elastomeric substrate comprising a sintered printed liquid metal elastomer pattern on the surface thereof.

One example provides the present multilayer self-healing electrically conducting elastomer film as or in soft, clastic, strain-insensitive electrical wiring, interconnections, pads, vias for flexible electronics, printed electronics, stretchable electronics, soft electronics and/or self-healing electronics. Flexible electronics are circuits and electronic components that can retain their function while being bent. Whereas flexible electronics can be bent, stretchable electronics can be elongated. Thus, stretchable electronics can be used in a wider application space while providing increased durability. Stretchable electronics can, in principle, conform to the skin or other biological tissue or be incorporated in new form factors, such as textiles and wearable electronics. Soft electronics include stretchable electronics, but the materials are also soft.

The soft electronics, connectors, wirings, and/or components thereof can be provided as patterned films and/or areas in multilayer structures, as attached on a surface of another material/substrate. They may be present in so called 2D geometric form, but they can be also formed as 3D forms comprising overlapping layers. The layers can be 3D printed or obtained by combining separate films or layers.

For interconnections, typically a more complex stretchable patterns have been used to neglect effect of tensile strain to the electrical conductivity and/or resistance of a wire: Some examples are Von Koch-curve, Peano curve, Hilbert curve, Moore curve, Vicsek fractal, Greek cross. These basic patterns can be further modified in order to achieve a desired level of deformability and strain insensitivity for the interconnections. However, with the present liquid metal elastomers there is no need to use complex patterns, because the resistance increase is negligible (i.e., is not sensitive to the stretching in this context). In practice, the interconnection may be a straight line. Usually, it is desired to avoid large angles in the electrical wiring for other reasons when making, for example, an electronic circuit layout. In such case the electrical wires may be skewed instead of 90 degrees angles. This also enables fabrication of denser electronics, as the geometry, length and/or shape of the electrically conductive parts plays minor role.

One example provides the present elastomer composites as or in an electronic skin (e-skin) product. Electronic skin refers to flexible, stretchable and/or self-healing electronics or products comprising thereof, that are able to mimic the sensory capabilities and functionalities of human or animal skin. This class of materials, or products, may comprise or exhibit physical, thermal, chemical or environmental sensing abilities that may be intended to reproduce, mimic and/or surpass the capabilities of human skin in their ability to respond and/or adapt to environmental changes or external stimulus, such as changes in temperature, humidity, vibration and/or pressure. Self-healing abilities in electronic skin are critical to potential applications of electronic skin in fields such as soft robotics.

Electronic skin may also refer to wearable skin-interfaced/on-skin, or implantable systems, which is/are to be applied onto organisms. Such material structure, or product, can act as or provide skin-interfaced electronics (skintronics) and/or other functionalities, such as disclosed herein. These materials, and other applicable materials and products disclosed herein, may represent a bioelectronic device, that can convert biological signals, such as physical, physiological, and metabolic signals, into measurable electrical signals. Such materials and devices can be used for example for health monitoring and/or for monitoring one or more features of skin and/or body.

One class or type of such devices are epidermal electronic devices, which can conform to the skin, providing a seamless interface for health monitoring and sensing applications. They comprise a class of integrated electronic systems that are ultrathin, soft, and lightweight. With the present materials they can be implemented in suitable thicknesses, breathability, softness, flexibility, and areal mass densities matched to the interface at the epidermis. Epidermal electronic devices can be mounted to epidermis leading to conformal electrical and mechanical contact and adequate adhesion based on van der Waals interactions alone is possible (if ultrathin), and they can provide feel insensitive contact to the skin, which is mechanically invisible to the user. They can be used in medical or sports applications and/or to realize human-machine interface.

Another class of technology and devices includes those related to biomedical engineering. Such devices can be used in implants or wearable devices that monitor health and deliver therapy. Implantable electronics made with the present materials can be used for example in devices capable of recording electrophysiological signals and/or for stimulating muscles and nerves, and which can be used throughout clinical medicine for various of purposes. Examples of such devices include sensor systems, such as those used for monitoring glucose. Glucose sensors can be implanted in subcutaneous tissues and determine agents or concentrations thereof from interstitial fluid.

The devices disclosed herein can be used in healthcare monitoring and athletic performance improvement. In one example stretchable electronics are integrated into wearable garments or patches for continuous health and/or fitness tracking/monitoring. For example, an ultrathin, compliant skin-like sensor and/or actuator technology can be pliably adhered onto the epidermis to provide continuous, accurate multisensory characterizations that are unavailable with other methods. Wearable systems comprising the present elastomer composite can monitor muscle activity and/or electrical activity of body, store data and deliver feedback for improvement for various purposes including therapy. Examples of such systems include physiological sensors, non-volatile memory and drug-release actuators.

One example provides the present multilayer self-healing electrically conducting elastomer films as or in soft, strain-insensitive electrical probes or wires for connecting soft components and devices to external measurement circuitry, or to computing (without high contact resistance at the interface). A probe may be a 3D dimensional body with an electrically conducting tip, which may be connected to a measuring device or electronics at the other end. The shape and/or size of the probe depends on intended use. For example, with an external measuring device and the soft probe, it is possible to measure electrical signals from the surface of fragile things/objects and at the same time get good mechanical and electrical contact with the surface without breaking it.

A soft connection/connector/cable can be made of a (patterned) multilayer self-healing electrically conducting elastomer film comprising a liquid metal elastomer film. This may provide a structure similar to a common FFC/FPC cable, but with the difference that it is made of self-healing materials, in which case it would have an built in adhesive at the surface of the cable. In such case it is not necessary to fix the cable separately. Such structure can adhere to, and work between both rigid electronics and a soft device, and between two soft or rigid devices, when the adhesive properties are suitable.

The present multilayer self-healing electrically conducting elastomer films can be used in sensors and/or devices or parts thereof capable of sensing and/or monitoring one or more stimulus and/or properties, and/or in devices or parts contributing to sensing. Soft sensors may include soft sensor component(s) capable of measuring mechanical, thermal, chemical, and/or environmental stimulus including but not limited to changes of tensile, shear, compressive forces, mechanical vibration, temperature, concentration of gases, and humidity. The sensors may measure or detect one or more stimulus, for example, through changes of resistance, capacitance, inductance, voltage, current, magnetic and/or electric field, shift in frequency and/or phase of electromagnetic wave, optical and/or acoustic loss, or combinations thereof. The measurements can be fed into a connected electrical control system. i.e. controlling means.

One example provides the present multilayer self-healing electrically conducting elastomer films as or in piezoresistive sensing layers in soft sensor components, such as with or without further functionalization. These may be or comprise planar patterned films that can either be attached to a planar substrate or to a substrate pre-/post-formed into a 3D shape. Therefore, the function of such piezoresistive membrane would then also be dependent on the working mechanism, type of structure or substrate it is integrated into. Thus, the location and shape of that piezoresistive sensing part shall also be considered according to what stimulus would be measured, and what the properties of the materials are, e.g. coefficient of thermal expansion, Poisson's ratio, swelling ratio, etc. For example, piezoresistive humidity, temperature and strain sensors would have a different structure also depending on their intended final use. The sensor elements made of patterned film(s) could then also form a matrix of the elements or sensors, if more measurement points per area would be desired. In this case, their patterned areas should be designed in consideration of the measurement resolution, and the electrical wiring needed to connect the piezoresistive sensors to the electronics.

One example provides the present multilayer self-healing electrically conducting elastomer films as or in strain-insensitive bioelectrodes, for low/high density biopotential measurements. Bioelectrodes may be round thin films which size is determined according to how good measurement resolution is required.

The bioelectrode usually requires two adjacent electrodes, the voltage difference between which is measured. If it is an electrode matrix, then e.g. two adjacent electrodes form a pair. The density and location of the electrodes in the matrix and in relation to the target to be measured can be determined, for example, according to where on the body the bioelectrode matrix is connected. In addition, an additional ground electrode is needed, which reduces e.g. measurement noise at low frequencies. The ground electrode can be located outside the electrode matrix as a separate electrode on the body.

One example provides the present multilayer self-healing electrically conducting elastomer films as or in soft, strain-insensitive electrodes and terminals, such as for soft electronics components including but not limited to organic or electroluminescent displays, solar cells, transistors, photodiodes, sensors, resistors, capacitors, and/or as or in soft, stretchable and/or self-healing batteries as both positive and negative electrode (cathode and anode). These may comprise patterned films, having patterns, shape, size and location in electronic structures dependent on the type and purpose of the device/structure. The thicknesses of the conductive layers/areas may be defined by the limits of the materials. Suitable thickness may be in the range of 20-40 μm.

The shape and number of electrodes is completely dependent on the structure, operation and type of a component. For example, a capacitor requires a different electrode structure than a transistor or a display. However, with a liquid metal elastomer, there is no need to consider the resistance change caused by stretching in the shape/location of the pattern, thus the shape of the electrodes can be more simplistic than in standard non-flexible electronics.

Displays usually have a dense matrix of electrodes that interact with emissive materials and make up the pixels of the screen. Terminals are used to connect the screen to the rest of the electronics, for driving function of individual pixels, etc. In practice, the present composites may be provided as film-like conductive layers that are in contact with the emissive materials.

In photodiodes the present multilayer self-healing electrically conducting elastomer films can be used in anodes, cathodes and/or terminals. The size and shape depend on structure and operating principle, but practically comprise film-like structures.

Sensors usually have two electrodes or terminals, in the case of typical the structure and operation principle. More advanced sensor structures can also have more electrodes if it is desired to measure many different stimuli and/or to combine different measurement methods into a single component. For example, three, four or more electrodes can be employed in one sensor.

Capacitors can have several electrodes if, for example, a multilayer capacitor is made with dielectrics and electrodes on top of each other. In addition, the terminals that connect the capacitor to other things can be made from the present composites. That is, the number of layers, the thickness and the surface area of the membrane would affect the capacitance, and the dielectric properties of the material that is sandwiched between the electrodes, i.e. the permittivity of the dielectric.

For batteries, a 3D structure may be in the shape of a regular battery, assuming that all materials are stretchable, and that such structure can be employed as a part of electronics design. Such a structure may comprise, for example, a large membrane structure where the necessary layers are assembled on top of each other, and the membrane structure is rolled into a smaller space and enclosed. In this example, there is one positive and one negative electrode, as well as two electrodes as terminals, from which contact can be made. In a planar structure, the number of electrodes may be higher. Further, if the performance of other active materials of the battery would decrease during stretching, it shall be taken into account in the shape/geometry of the component, even if the materials are otherwise stretchable

One example provides the present multilayer self-healing electrically conducting elastomer films as or in soft, stretchable, wearable and/or on-body integrated antennas including but not limited to dipoles, loops, coils, patch antennas, phase shifting coaxial transmission lines, monopoles, reconfigurable antennas and filters. In practice, these may be substantially planar conductive and patterned structures, where the limitations of the thickness of the layers come from the materials and their manufacturing methods. These structures may be provided on a flat surface. For example, the shape/size of such resonator shall be designed to be suitable for the frequency range in question, also taking into account the electrical properties of the materials.

### EXAMPLES

### Example 1: Liquid Metals without Fillers

Liquid metal alloys comprising cGa_{0.69}In_{0.22}Sn_{0.09} and eGa_{0.755}In_{0.245} mixtures were used for preparing the self-healing electrically conducting elastomer composites. It was noted that the composition of the eutectic mixture has an impact to the temperature wherein the metal alloy is present in a liquid form.

The volume of the liquid metal in the elastomer composite was varied in the range of 5-90% by volume. This has an impact to the electrical properties of the elastomer composite. It was found that when the volume of liquid metals remained at 45% or less, the elastomer composite was electrically insulative. With increased volume of liquid metal, the elastomer composite exhibited good electrical conductivity. It was found out that about 55% or more by volume produced electrically conductive composite, which found many uses in various applications.

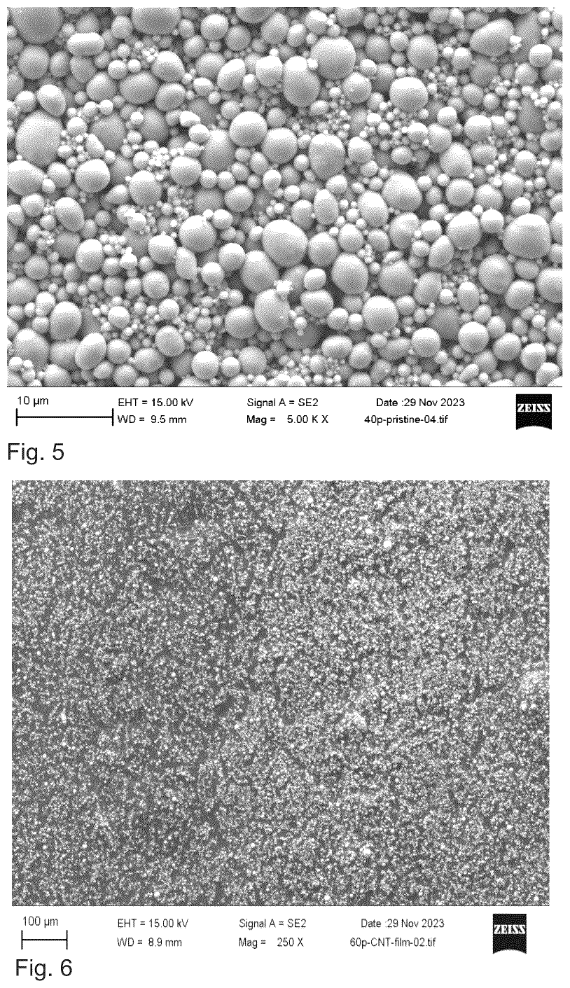

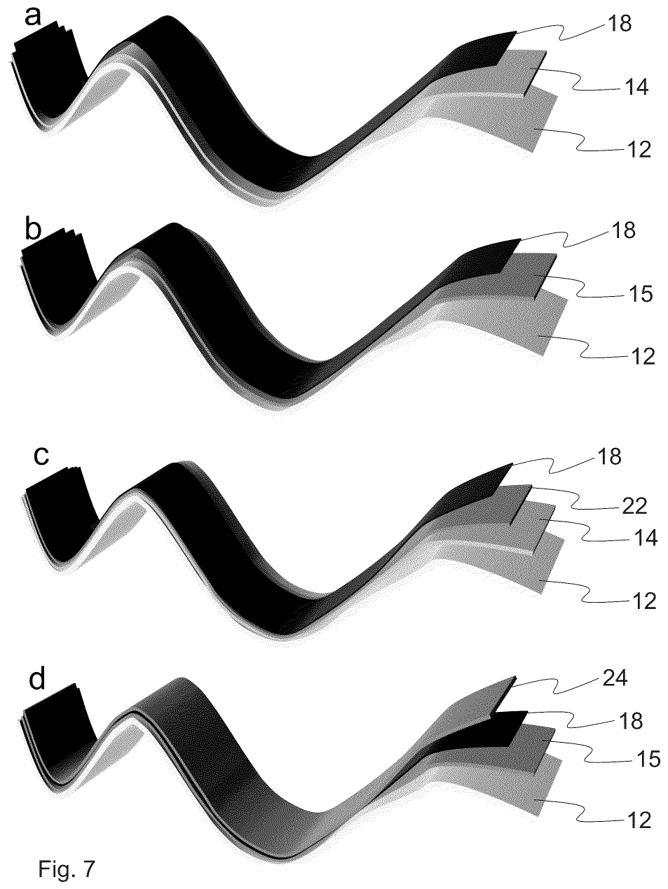

The eutectic mixtures were ultrasonicated in a solvent to obtain nano/microparticles, as can be seen in SEM image of FIG. 5. FIG. 12 shows particle size analysis of LMMPs. The particle size distribution was measured with Zetasizer Nano ZS from a diluted liquid metal mixture. It was found out that the formed microparticles enabled enhanced blending with the elastomer components, as a thin oxide layer of about 2-20 nm is formed on the surface of the particles. The surface oxide layer facilitated the mixing of the particles to other materials, such as polymers. The liquid metal microparticle (LMMP) size could be controlled and adjusted by changing the composition of the mixture and ultrasonication parameters. With the control over the ultrasonication parameters affecting the size of LMMP, properties of the final material could be further adjusted.

The average particle size (diameter) obtained in the ultrasound treatment was between 100 nm to 30 micrometers, depending on the composition of the mixture and the parameters of the ultrasound treatment. In the ultrasound treatment parameters such as power, amplitude and sonication time could be controlled, wherein for example a longer sonication time produced more homogenous particle distribution and smaller average particles size, especially when the power and amplitude were unchanged. Increasing the amount of liquid metals compared to the amount of the solvent and other components could broaden particle size distribution, if the ultrasonication parameters were unchanged. With larger amount of liquid metal, a longer sonication time was required to obtain a desired particle size and the distribution. In general, the smaller particle size enables better mixing with the other components, thus more homogenous liquid metal composite. This was found advantageous for the laser sintering of ECLME once above the percolation threshold.

The used solvent was selected according to need, such as to completely cover the liquid metal mixture in a narrow glass vial. The shape and cross-sectional area of the glass vial had also a specific impact, depending on the area of the tip of the ultrasound mixer. The particle formation was optimal when the area of the tip was close to the cross-sectional area of the glass vial.

More solvent was added during the ultrasound treatment, if necessary. However, the amount of unevaporated solvent could have an impact to the viscosity of the final mixture and shall be taken into account in the preparation of the final products by methods such as 3D printing, inject printing, tape casting etc., which all require a different viscosity.

In some cases, the solvent was allowed to evaporate completely so that liquid metal particle powder was obtained without solvent. However, when selecting the solvent, it was found to be important to enable a good liquid metal particle formation, and to enable compatibility with the elastomer components. Different solvents were tested, and isopropanol and toluene were found to be especially suitable for the present purposes. Of these two, isopropanol was found to produce better results for the formation of the liquid metal particles.

After forming the liquid metal particle mixture or powder, which may be considered as Mixture 1, it could be mixed with the elastomer components. Sylgard™ 184 silicone elastomer kit was partly used for forming the elastomers, the kit comprising Components A and B. Component A comprises a siloxane base and Component B a siloxane crosslinker.

Boron trioxide (B₂O₃) nanoparticles were mixed with Component A. The components were mixed by grinding in mortar with pestle to form Mixture 2 (M2). PDMS-OH was added to the Mixture M1 (M1; containing LMMP), and M1 with Triton™ X-100 was added after this to the M2. As a final step Component B was added to combined mixture of M1 and M2, to crosslink the elastomer composites. As a result, a dark brown paste was formed, which was moldable or printable depending on the viscosity of the final mixture. The viscosity could be controlled by the amount of solvent, and by the compositions of the liquid metal particle mixture/powder, and elastomer matrix.

The elastomer composite paste was formed into films with varying thicknesses.

### Example 2: Liquid Metals with Carbon Nanotubes

The liquid metals were provided as explained in Example 1.

Carbon nanotubes of different types were tested, including single walled or multiwalled carbon nanotubes. In one example, the carbon nanotubes were COOH-functionalized.

Carbon nanotubes were added to the mixture of liquid metals and solvent, and the mixture was ultrasonicated as in Example 1.

It was found out that single walled carbon nanotubes can provide, in general, a better electrical conductivity (if below the percolation threshold of the liquid metal composite) but are significantly more expensive. While the multiwalled carbon nanotubes have lower electrical conductivity, they still could enhance the connectivity and distribution of the LMMPs within the elastomer matrix, which is a major purpose of the present method.

As can be seen in the SEM image of FIG. 6, the addition of a small amount of carbon nanotubes prevents the agglomeration of liquid metal particles at large volume loadings, thus resulting in better distribution of the LMMPs in the composite and formation of more homogenous composite.

After forming the liquid metal particle mixture or powder comprising carbon nanotubes (Mixture 1), the elastomer composites were prepared as explained in Example 1

The elastomer composite paste was formed into films.

### Example 3: Liquid Metals with Carbon Nanotubes and Hydroxypropyl Cellulose

Elastomer composites were prepared in general as explained in Example 2, but adding also hydroxypropyl cellulose as a further filler. Other cellulose derivatives were also tested in an analogous manner.

The hydroxypropyl cellulose (HPC) was mixed with deionized water. HPC could be dissolved in water, but also in organic solvents. The amount of HPC with respect to the used deionized water defines i.e. the viscosity of the mixture. The viscosity was relatively high already when the amount of HPC was close to 20% by weight. After mixing the HPC with deionized water, a desired amount of carbon nanotubes was added, and the mixing was continued. Tested amounts of carbon nanotubes were in the range of 0.5-5.0% by weight.

Liquid metals particles were first mixed with the solvent used to obtain Mixture 1, and the elastomer composites were prepared as explained in Examples 1 and 2.

Films were prepared from the obtained elastomer composite paste with varying thicknesses. The microstructure and properties of the films significantly differentiated from the films prepared in Examples 1 and 2. There were no visible liquid metal particles on the surface of the film in larger amounts. It was observed that the formed micro-structure of the composite film, wherein the liquid metal particles are encapsulated within the cellulose matrix, is advantageous for a subsequent method step, wherein the surface of the film is then treated with a laser.

Stretchable self-healing elastomer composites were obtained from Examples 1-3. For example, the SEM images demonstrated the change of the microstructure of the composite with over 125% uniaxial stretching for LMMP-CNT and LMMP-CNT-HPC. However substantially higher stretchability was obtained, as explained in the specification.

### Example 4: Mixing Methods 1-3

The liquid metal nano/microparticle (LMMP) paste was mixed with the elastomer components as shown by the four different methods.

The LMMP paste comprised solvent and LM, with either CNT, cellulose, or both CNT and cellulose, and the obtained elastomer composites were denoted as μLM-CNT, μLM-HPC, μLM-CNT-HPC (or as LMMP-CNT, LMMP-HPC, LMMP-CNT-HPC).

The mixing process of Methods 1-3 (FIGS. 2-4) comprised the following.
1. After preparation of LMMP paste with a probe ultrasonication, the PDMS-OH component was added to a glass vial where the LMMP paste was mixed with lab spatula, to form a homogenous mixture 1 (M1).
2. Boron trioxide nanoparticles (B₂O₃ NPs) were mixed with component A of Dow Corning Sylgard™ 184 by grinding in mortar with pestle to form mixture 2 (M2). The mixing was continued until homogenous paste with uniform color was formed.
3. M1 was added to M2, and the mixture was further grinded in mortar with pestle to form homogenous paste.
4. If needed, Triton™ X-100 was added to the mixture and mixing was continued. The amount of Triton™ X-100 was calculated in relation to the amount of elastomer components (step 1), and it was in the range of 0.1-13% by weight. It was found out that preferably it shall be in the range of 0.1-6% by weight, and more preferably in the range of 0.1-2.5% by weight.

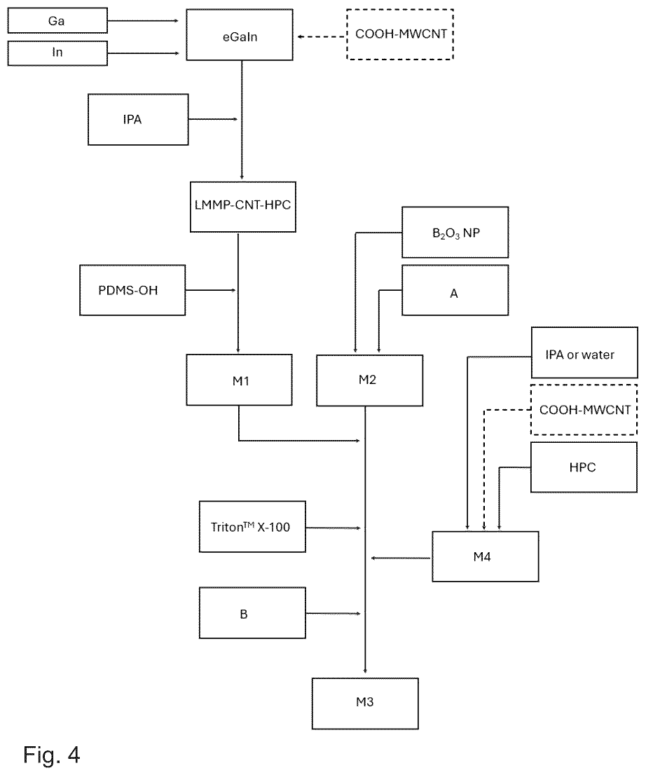

The mixing process of Method 3 (FIG. 4) comprised the following
1. After preparation of LMMP paste with the probe ultrasonication, the PDMS-OH component was added to a glass vial where the LMMP paste was mixed with a lab spatula to form a homogenous mixture 1 (M1).
2. Boron trioxide nanoparticles (B₂O₃ NPs) were mixed with component A of Dow Corning Sylgard™ 184 by grinding in mortar with pestle to form mixture 2 (M2). The mixing was continued until homogenous paste with uniform color was formed.
3. M1 was added to M2, and the mixture was further grinded in mortar with pestle to form homogenous paste.
4. Mixture 4 (M4) was formed by probe ultrasonicating solvent and HPC, and additionally CNT. After ultrasonication M3 was added to the mixture made of M1 and M2.
5. If needed, Triton™ X-100 was added to the mixture and the mixing was continued. The amount of the amphiphilic surfactant was calculated in relation to the amount of elastomer components (step 1), and it was in the range of 0.1-13% by weight. It was found out that preferably it shall be in the range of 0.1-6% by weight, and more preferably it may be in the range of 0.1-2.5% by weight.
6. Component B of Dow Corning Sylgard™ 184 was added to the mixture above and the mixing was continued. The final mixture was referred to as mixture 3 (M3).

Outcome of Methods 1, 2, and 3 was a homogenous elastomer composite paste, that was used in additive manufacturing or film formation.

### Example 5: Surface Treatment of the Films

As the elastomer composites obtained from Examples 1˜4 were not electrically conductive as such, the films had to be further processed to achieve high electrical conductivity. In practice all the composites were highly resistive or poorly electrically conducting, independently of the liquid metal or filler content, or phase separation degree in the composite, as the liquid metal particles have an oxide layer on the surfaces thereof preventing the flow of electrons and physical contact of the inner core of the particles. When the films were processed with the present methods it was possible to obtain highly electrically conductive composites (similarly to pure liquid metal).

### Example 6: Printing on a Substrate and Electrical Conductivity

The liquid metal elastomers were printed on different substrates.

It was found out that effect of the film thickness to the electrical conductivity is minor. However, 20-100 μm thickness was found sufficient to produce high quality printed patterns, or films/coatings/layers with good electrical conductivity.

It was found out that printing and/or laser sintering direction influences the final electrical conductivity on ordinary (non-self-healing) substrate; either by improving or decreasing it. The electrical conductivity also depends on the substrate on which the liquid metal elastomer is made on. For example, printing along the smallest dimension of pattern (in the case of simplistic line) is not possible on substrate with poorer wettability (unless the wettability is improved, e.g., with surface modifications).

It was found out that on some soft substrates, the liquid metal elastomer is not electrically conductivity even after laser sintering, such as Reynolds Ecoflex® 00-20 silicone rubber. The electrical conductivity improves by factor of 1.6-1.8 on self-healing elastomers, if compared to conventional non-healable elastomers, e.g., EC7 (780-1620 S cm⁻¹) vs. Reynolds Dragon Skin® 10 medium silicone rubber compound (470-880 S cm⁻¹). Printing on intermediate layer (placed on top of the substrate) made of self-healing elastomer generally improves the electrical conductivity and achieving a conductive layer even on Reynolds Ecoflex® 00-20 silicone rubber is then possible.

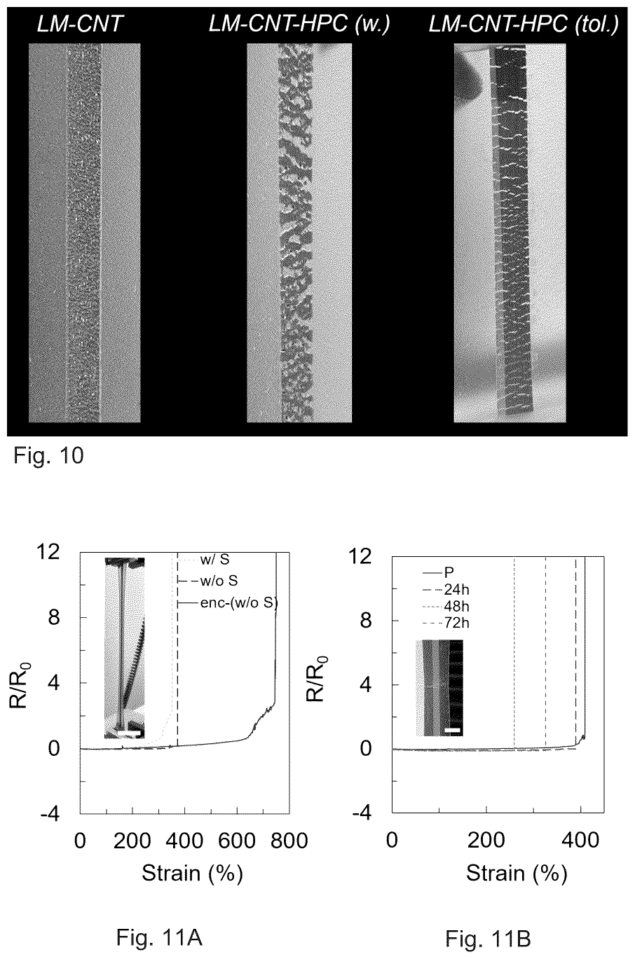

Photographs of different liquid metal elastomer composition made by using carbon nanotubes, by adding of mixture of carbon nanotubes and hydroxypropyl cellulose mixed with deionized water, and carbon nanotubes and hydroxypropyl cellulose mixed with toluene are shown in FIG. 10. The liquid metal elastomers are printed on Dragon Skin™ elastomer and shown under uniaxial stretching.

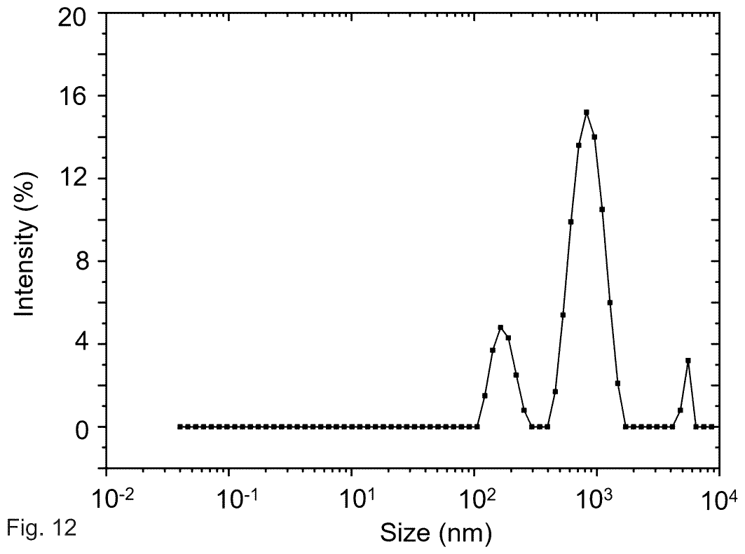

As shown, R/R₀ was measured as a function of uniaxial stretching (FIG. 11). The printed conductors are denoted as follows: in a) w/S=liquid metal elastomer (LME) is made with a surfactant, w/o S=LME made without a surfactant, enc-(w/o S)=encapsulated conductor and LME layer made without a surfactant, and in B) P=pristine conductor and 24/48/72 h refer to the self-healing time measured from the point of time where the sample was completely cut through on specific location. The photographs show the pristine sample under stretching (on the left, scale bar 25 mm) and self-healed sample which has been cut and then healed (on the right, scale bar=0.3 mm). The LME were printed onto a self-healing elastomer substrate (EC7).

The electrical conductivities of laser sintered traces vertically printed and hatched on Dragon Skin™-elastomer increases approximately from 3.4.10-3 S/m to 876 S cm⁻¹ with the volume of LM increasing from 55 to 65 vol. % The properties are measured as a mean+/−STD for 10 samples.

The dimensions and geometry of the printed traces were fixed in all tests. Typical trace dimensions were 49.0×5.0 (mm) (length×width), and the thickness of the traces were defined from the optical microscopy images. After printing and laser sintering, the traces were approximate 25-50 μm in thickness (depending on the substrate and elastomer composition).

The values for horizontal printed traces are less (1.1·10⁻³ S/m to 475 S cm⁻¹). These electrical conductivity values for the ECLME elastomers are without application of tensile strain (i.e., in relaxed state). Interestingly, the electrical conductivities increase to 781±235-1613±485 S cm⁻¹ when ECLME are printed on self-healing elastomer (EC7) substrate (increase by a factor 1.84 on average).

Generally, the increase of the electrical conductivity with the volume loading of LM (after laser sintering) can be explained by the common percolation theory:

$$σ = {{σ}_{0} ( φ - {φ}_{c} )}^{n} ,$$

where σ₀ is the electrical conductivity of the pure liquid metal (3.4·10⁶ Sm⁻¹), φ is the volume fraction of the filler (e.g., eGaIn) in the composite, φ_{c} is the percolation threshold, and n is the percolation exponent. Based on the measurement results, the percolation threshold is 55 vol. %, and with the percolation exponent of 1.6, the theoretical prediction fits well to the experimental data using the percolation theory. As shown, the electrical conductivity of the ECLME arc dominated by LM at or above the percolation threshold. Increasing the amount of MWCNT-COOH did not increase the electrical conductivity of the ECLME. The electrical conductivities were 876±210, 629±70 and 876±209 S cm⁻¹ for 0.75, 1.50, and 2.25 vol. % of CNT@65 vol. % LM, respectively.

The electrical conductivities of the ECLME elastomers are highly dependent on the type of elastomeric substrate on which they are casted on. Also, use of cellulose during mixing significantly increases the electrical conductivities as the cellulose encapsulates the LMMP and the segregation increases in the elastomer matrix.

The choice of self-healing elastomer and its composition does not affect the electrical properties of liquid metal elastomer. It was found out that the amount of carbon nanotubes does not improve the electrical conductivity assuming the volume loading of liquid metal is above the percolation threshold (55 vol. %)

In comparison, on Reynolds Vytaflex™ elastomer, the electrical conductivities of ECLME with 65 vol. % LM and 0.75 vol. % MWCNT-COOH were 470±117-1187±237 S cm⁻¹ (which were comparable to that observed in Reynolds Dragon Skin™ elastomer). By using a non-conductive self-healing layer (EC7) as intermediate layer between Reynolds Vytaflex™ elastomer and ECLME, the electrical conductivity increased up to 2417±388-2535±671 S cm⁻¹ (by a factor up to ˜2.13).

Interestingly, the printed ECLME traces were not electrically conductive after the laser sintering on Reynolds Ecoflex™ elastomer. By using a non-conductive self-healing elastomer as intermediate layer, it was possible to achieve electrically conductive ECLME traces also on the Ecoflex™ elastomer. The electrical conductivities were in the range of 129±39-1154±150 S cm⁻¹ which were significantly lower than when made on Reynolds Dragon Skin™ or Vytaflex™ elastomers.

The electrical conductivities increased up to 3000±1751-4688±1983 S cm⁻¹ on Reynolds Dragon Skin™-elastomer after the laser sintering if hydroxypropyl cellulose is used as a part of the mixing process, when 1 gram of MWCNT-COOH/HPC/water dispersion is added to the other components, where the amount of HPC in relation to water is 20 wt. %, and the amount of MWCNT-COOH is 2 wt. % in relation to the HPC and water. The amount of CNT and HPC added to other components could be then controlled by controlling the amount of mixture added with other components.

If the amount of HPC was increased, the viscosity increased significantly after 20 wt. % The laser sintering improved the electrical conductivity by over factor of 10⁸ (i.e., the films are highly resistive/non-conductive before sintering). This enabled also preparation of continuous LM films, where only certain areas of the films were activated to be electrically conductive by the laser sintering to be electrically conductive. Generally, the higher the resistivity of the composite is before lasering, the better the electrical conductivity is after the sintering, which could be strongly related to the particle segregation.

With the use of non-conductive, self-healing substrate (EC7) as an intermediate layer between the ECLME elastomer and Reynolds Dragon Skin™-elastomer, the electrical conductivities were up to 871±210-2220±508 S cm⁻¹. Thus, the electrical conductivities increased by a factor up to 2.55 by only adding a non-electrically conductive self-healing elastomer layer in between the Dragon Skin™-elastomer and ECLME.

In comparison, the electrical conductivities with HPC-based ECLME (0.25 g of HPC/CNT/water solution instead of 1 g (same ratios than above)) were:
6657±2186 S cm⁻¹ on Reynolds Dragon Skin™ elastomer (improvement by a factor up to 1.42 with less amount of CNT/HPC water)·
4584±1998 S cm⁻¹ on self-healing elastomer (EC7).
6619±1274 S cm⁻¹ on Reynolds Ecoflex™ elastomer with EC7.
7089±2495 S cm⁻¹ on Reynolds Dragon Skin™ with EC7
3811±1477 S cm⁻¹ on Reynolds Vytaflex™ elastomer with EC7

The highest measured (non-strained) electrical conductivity was 9473 S cm⁻¹ on Reynolds Dragon Skin™ elastomer for ECLME with HPC. The surface of Reynolds Ecoflex™ elastomer is extremely rough which is why the intermediate layer is important to achieve electrically conductive ECLME.

### Example 7: Two-Dimensional Patterning with Hatching, Cutting, or Drilling Tool

The two-dimensional patterning was possible with any of the tools available in the laser system (cutting, drilling, or hatching). However, cutting or drilling tools were found generally more suitable for two-dimensional patterning.

After cutting the films, the areas of the films that are not needed were removed. This could be easily done by peeling the clastic autonomously self-healing elastomer films along the cut lines. This caused clean detachment of the films from both the patterned area of the film and the carrier substrate without any residue. The peeling and stretching of the films did not work if the materials were not elastic enough, and/or if they were too viscous for the removal, or if the adhesion to the carrier substrate was too strong. Thus, using a carrier substrate which is not adhering well to the materials was found essential when patterned films are cleaned afterwards, and transferred to another substrate from the donor/carrier substrate. Generally, non-silicone coated polyethylene terephthalate (PET) film works as a carrier substrate if the autonomously self-healing elastomers contained any amount of Triton™ X-100, and/or if the viscous nature of the materials was reduced by the composition to reduce the speed of self-healing (e.g., by reducing amount of B₂O₃ NPs, incorporation of carbon nanotubes). In other cases, DuPont™ Tedlar® polyvinyl fluoride release films (or similar) with excellent anti-stick properties could be used to avoid autonomously self-healing elastomer adhesion (if the layers are transferred afterwards).

### Example 8: Multilayer Structures

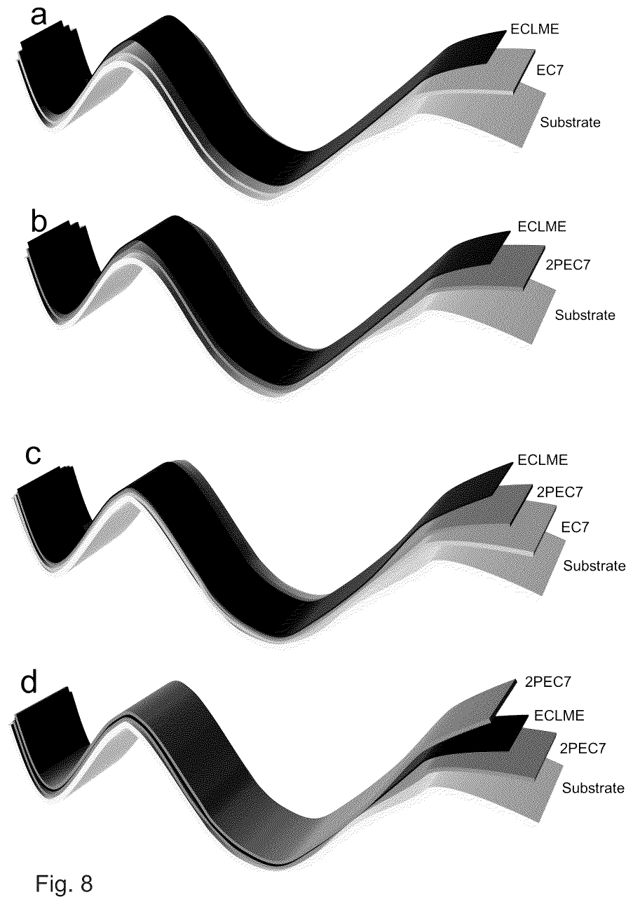

Multilayer structures were prepared by using materials disclosed in previous examples. The multilayer structures are presented schematically in FIGS. 8a-d.

FIG. 8 shows examples of multilayered film structures prepared as disclosed herein. FIG. 8a shows a structure wherein a non-conductive self-healing elastomer layer comprising EC7 elastomer was casted and crosslinked on a substrate layer. On top of the EC7, a layer of ECLME comprising 65% by volume of liquid metal, comprising gallium as main phase, and 0.75 by weight of carboxylic acid functionalized MWCNTs was applied (i.e., EC7-LM65-CNT0.75). After printing, the ECLME was surface activated with laser to enhance conductivity.

FIG. 8b shows a structure wherein an electrically conductive, self-healing PEDOT-based elastomer layer with composition denoted as 2PEC7 was printed and crosslinked on a substrate layer. On top of the 2PEC7, a layer of EC7-LM65-CNT0.75 was printed. After printing the final layer, the ECLME was surface activated with laser to enhance conductivity.

FIG. 8c shows a structure wherein a non-conductive, self-healing elastomer layer with composition EC7 was casted and crosslinked on a substrate layer. On top of the EC7, a layer of 2PEC7 was printed, and on top of 2PEC7a layer of EC7-LM65-CNT0.75 was printed. After printing the final layer, the ECLME was surface activated with laser to enhance conductivity.

FIG. 8d shows a structure wherein an electrically conductive, self-healing PEDOT-based elastomer layer with composition 2PEC7 was printed and crosslinked on a substrate layer. On top of the 2PEC7, a layer of EC7-LM65-CNT0.75 was printed. After printing of ECLME, the surface activated with laser to enhance conductivity. On top of the surface activated ECLME layer, another layer of 2PEC7 was printed and crosslinked.

Conductor structures comprising DS+2PEC7, DS+ECLME, and DS+2PEC7+ECLME were compared. The layers were in the disclosed order and the structures did not comprise encapsulation.

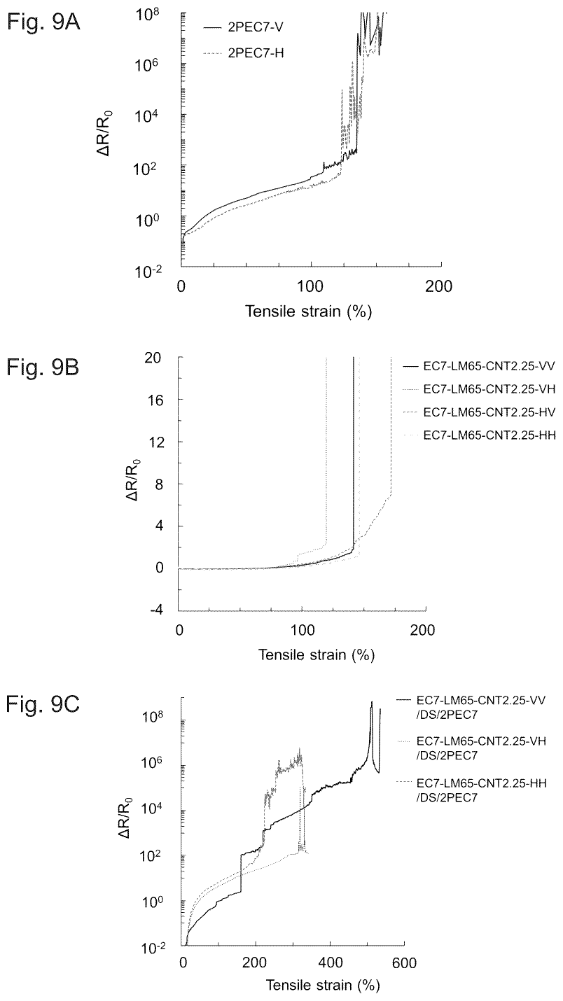

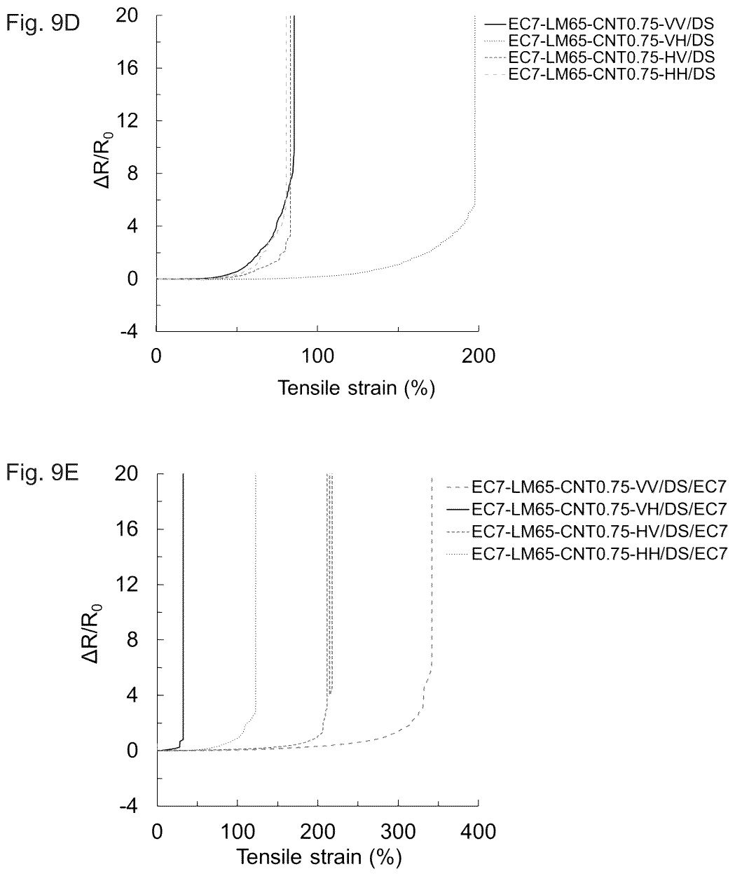

FIGS. 9a-e shows relative resistance change (ΔR/R₀) plotted as a function of uniaxial tensile strain for a) 2PEC7 (PEDOT-based elastomer compositions) on Dragon Skin™ elastomer, b) EC7-LM65-CNT2.25 composition of electrically conductive liquid metal elastomers (ECLME) on Dragon Skin™ elastomer, c) multilayered conductor consisting of substrate, 2PEC7 intermediate layer, and a second conductive layer made of EC7-LM65-CNT2.25 ECLME, d) EC7-LM65-CNT0.75 ECLME on Dragon Skin™ elastomer, and e) multilayer conductor consisting of substrate, EC7 as the intermediate layer, and the first conductive layer made of EC7-LM65-CNT0.75 ECLME. In this case, for example, vertical printing and/or lasering (denoted with “V”) is along the uniaxial stretching direction. The first and the second letter indicates the printing and lasering direction, respectively (in the case of ECLME).

LM65 refers to 65% of liquid metal by volume. CNT0.75 and CNT2.25 refer to 0.75% and 2.25% by weight of carboxylic acid functionalized MWCNTs, respectively. 2PEC7 refers to layer of 2PEC7 on Reynolds Dragon Skin™ elastomer substrate (similarly to DS/2PEC7). In 2PEC7, the ratio of insulating to conducting phases is 2:1, and EC7 is the elastomer composition used as the insulating phase. DS refers to Reynolds Dragon Skin™ elastomer used as a substrate.

For example, for 2PEC7 on DS (FIG. 9a), the gauge factor (GF) (i.e., relative resistance change divided with the strain (ΔR/R₀)/ε) increases from approx. 0.02@ε=0-18% to 237.40@ε=30-130% tensile strain with the deformation, before the conductor completely breaks around ε=130-150% due to cracking of the conductive layer. Similarly, for EC7-LM65-CNT2.25 (FIG. 9b) on DS the GF increases from approx. 0.03@ε=0-70% to 0.83@ε=70-130%, before the conductors completely break around ε=120-170% due to cracking of ECLME layer, depending on the printing and lasering direction of ECLME. With lower amount of CNT (FIG. 9d), the stretchability of conductor is more limited, and larger GF is observed between ε=50-100%. In comparison, when using intermediate layer made of EC7 (FIG. 9e), the overall stretchability of the conductors increases up to 340% strain.

For example, for multilayered conductor structure with 2PEC7 as the intermediate layer (FIG. 9c), the GF was approx. 0.7@ε=0-40%, and then increases to 15-25@ε=40-450%, before the conductors completely break around 350-550% strain. With the use of 2PEC7 as the intermediate layer, no crack formation was found in either one of the conductive layers.

1. A method for preparing a multilayer self-healing electrically conducting elastomer film, the method comprising
providing an electrically insulating substrate layer comprising an elastomer matrix,
applying a first layer comprising a self-healing elastomer on top of the electrically insulating substrate layer,
crosslinking the first layer comprising a self-healing elastomer with the electrically insulating substrate layer,
applying a layer comprising a self-healing electrically conducting liquid metal elastomer composite comprising gallium as main phase on top of the first layer comprising a self-healing elastomer, and
activating the surface of the layer comprising a self-healing electrically conducting liquid metal elastomer composite with laser to improve electric conductivity of the layer.

2. The method of claim 1, wherein the activating comprises laser-sintering and/or laser processing to remove oxide layer from the layer comprising a self-healing electrically conducting liquid metal elastomer composite to improve electrical conductivity thereof.

3. The method of claim 1, comprising treating one or more of the layers with a laser to form one or more patterns to the layer(s).

4. The method of claim 1, comprising
applying a second layer comprising a self-healing electrically conducting elastomer on top of the first layer, before applying the layer comprising a self-healing electrically conducting liquid metal elastomer composite on top of the first layer and the second layer.

5. The method of claim 1, comprising applying a third layer comprising a self-healing elastomer on top of the layer comprising a self-healing electrically conducting liquid metal elastomer composite.

6. The method of claim 1, comprising providing nanostructured and/or nanoscale materials, and/or cellulose, and incorporating the nanostructured and/or nanoscale materials and/or the cellulose to surface of the substrate, to the second layer comprising a self-healing electrically conducting elastomer and/or to the layer comprising a self-healing electrically conducting liquid metal elastomer composite.

7. The method of claim 1, comprising combining the multilayer self-healing electrically conducting elastomer film with one or more electrical components to manufacture an electronic device.

8. The method of claim 1, wherein the first layer comprises an electrically conducting self-healing elastomer.

9. The method of claim 1, wherein the first layer comprising a self-healing elastomer, the second layer comprising a self-healing electrically conducting elastomer and/or the third layer comprising a self-healing elastomer comprise PEDOT:PSS and optionally one or more fillers selected from metal nanoparticles; metal nanowires; carbon black; pyrolyzed lignin; graphite; carbon nanotubes; polymeric nanorods; nanofibrils; graphene, nanolayers selected from graphite, metallic layers and compounds comprising atomically thin layers of transition metal carbides, nitrides, or carbonitrides.

10. A multilayer self-healing electrically conducting elastomer film, comprising
an electrically insulating substrate layer comprising an elastomer matrix,
a first layer comprising a self-healing elastomer crosslinked with the electrically insulating substrate layer, and
a layer comprising a self-healing electrically conducting liquid metal elastomer composite comprising gallium as main phase on top of the first layer comprising a self-healing elastomer.

11. The multilayer self-healing electrically conducting elastomer film of claim 10, wherein
the first layer comprises an electrically conducting self-healing elastomer.

12. The multilayer self-healing electrically conducting elastomer film of claim 10, further comprising
a second layer comprising a self-healing electrically conducting elastomer on top of the first layer, wherein the layer comprising a self-healing electrically conducting liquid metal elastomer composite is on top of the second layer.

13. The multilayer self-healing electrically conducting elastomer film of claim 10, wherein the surface of the layer comprising self-healing electrically conducting liquid metal elastomer composite is a laser sintered and/or an electrical conductivity-improved layer.

14. The multilayer self-healing electrically conducting elastomer film of claim 10, wherein one or more layers of the film is/are laser-patterned.

15. The multilayer self-healing electrically conducting elastomer film of claim 10, further comprising third layer comprising a self-healing elastomer on top of the layer comprising a self-healing electrically conducting liquid metal elastomer composite.

16. The multilayer self-healing electrically conducting elastomer film of claim 10, comprising nanostructured and/or nanoscale materials, and/or cellulose as functional fillers on surface of the substrate, in the second layer comprising a self-healing electrically conducting elastomer and/or in the layer comprising a self-healing electrically conducting liquid metal elastomer composite.

17. The multilayer self-healing electrically conducting elastomer film of claim 10, wherein the first layer comprising a self-healing elastomer, the second layer comprising a self-healing electrically conducting elastomer and/or the third layer comprising a self-healing elastomer comprise PEDOT:PSS and optionally one or more fillers selected metal nanoparticles; metal nanowires; carbon black; pyrolyzed lignin; graphite; carbon nanotubes; polymeric nanorods; nanofibrils; graphene, nanolayers selected from graphite, metallic layers and compounds comprising atomically thin layers of transition metal carbides, nitrides, or carbonitrides.

18. A method for preparing an electronic device, or part thereof, the method comprising
providing one or more multilayer self-healing electrically conducting elastomer films of claim 10,
providing one or more electrical components, and
combining the one or more multilayer self-healing electrically conducting elastomer films with the one or more electrical components to obtain an electronic device, or a part thereof, comprising the multilayer self-healing electrically conducting elastomer film(s).

19. An electronic device, or a part thereof, comprising the multilayer self-healing electrically conducting elastomer film of claim 10.

20. The electronic device of claim 19, wherein the electronic device is, or comprises, one or more selected from an antenna, a sensor or a bioelectrode, a measurement circuitry, a piezoresistive sensing layer, an electrode, a terminal of electronics component, a heating element, an electromagnetic device, a soft robot, printable electronics, stretchable electronics, soft electronics, self-healing electronics, electronic skin, implantable electronics and wearable electronics.
